(19) United States
(12) Patent Application Publication
(10) Pub. No.: US 2026/0164154 A1
(43) Pub. Date: Jun. 11, 2026

(54) DIPOLE LOW FREQUENCY ACOUSTIC WAVE DELIVERY SYSTEM

(71) Applicant: Logitech Europe S.A., Lausanne (CH)

(72) Inventors: Daniel Ryan MARQUEZ, Vancouver, WA (US); Matthew James GREEN, Vancouver, WA (US); Calhoun Ernst ZABEL, Vancouver, WA (US); Faith Renae BERGSTROM, Camas, WA (US)

(21) Appl. No.: 19/326,718

(22) Filed: Sep. 11, 2025

Related U.S. Application Data
(60) Provisional application No. 63/729,153, filed on Dec. 6, 2024.

(51) Int. Cl. H04R 1/02; H04R 1/22

(52) U.S. Cl. CPC H04R 1/025; H04R 1/227; H04R 2201/028

(57) ABSTRACT

Embodiments described herein relate to a dipole speaker assembly. The dipole speaker assembly includes a cabinet with a first end and a second end. A driver is positioned within the cabinet and directed towards an end of the cabinet. Positive sound waves emit through the end of the cabinet in which the driver is directed towards and negative sound waves emit through the opposite end of the cabinet to create localized audible regions near the two ends of the cabinet that dissipate further away from the cabinet.

### CROSS-REFERENCES TO RELATED APPLICATIONS

This application claims benefit of and priority to U.S. Provisional Patent Application Ser. No. 63/729,153, filed on Dec. 6, 2024, which is incorporated herein by reference in its entirety.

### BACKGROUND

### Field

Embodiments described herein generally relate to subwoofers, or loudspeakers designed to reproduce low frequency audio. More specifically, embodiments described herein relate to dipole subwoofers.

### Description of the Related Art

Subwoofers may be used in a variety of audio environments, including theaters, auditoriums, and home entertainment systems. In these environments, subwoofers are conventionally utilized to reproduce sounds within a low frequency range. Subwoofers may be used independently or in conjunction with other loudspeakers that reproduce sounds within a higher frequency range. However, listeners in these environments often notice the low frequency sounds produced by the subwoofers more than the other loudspeakers. The low frequency audible sounds correspond to longer wavelengths, which have a lower propagation impedance (e.g., lower resistance to sound waves travelling through a medium) and can resonate with objects to a higher degree than higher frequency sounds generated by an audible source. The lower propagation impedance of the low frequency audible sounds can cause an undesirable amount of locally positioned individuals to be exposed to a significant portion of the generated low frequency sound waves and/or cause objects in close proximity to the audible source to shake and vibrate. The exposure to the generated low frequency sound waves can be an annoyance for individuals positioned outside of an intended listening environment.

Accordingly, there is a need for a speaker assembly that is configured to control the delivery of acoustically generated sound waves to desired areas within an environment and/or to limit the extent by which acoustically generated sound waves are transmitted to other areas outside of the desired areas of the environment.

### SUMMARY

Embodiments described herein generally relate to speaker assemblies. More specifically, embodiments described herein relate to dipole speaker assemblies with two ports. Positive pressure sound waves travel through a first port and negative pressure sound waves travel through a second port.

In one embodiment, a dipole speaker assembly is provided. The dipole speaker assembly includes a cabinet and a driver positioned in the cabinet. The cabinet includes a body having an internal surface and an external surface. An internal region of the cabinet is at least partially enclosed by the internal surface of the body. The cabinet includes a first opening and second opening formed in the body. The first opening is positioned at a first end of the cabinet and the second opening is positioned at a second end. The cabinet has a cabinet length extending from the first end to the second end. The driver includes a diaphragm that separates a first side of the driver from a second side of the driver. The driver is sealably coupled to the body so that at least a portion of the internal region disposed on the first side of the driver is fluidly isolated from the second side of the driver. The driver is configured to deliver sound waves at frequencies less than a first frequency that has a corresponding first wavelength. The cabinet length is at least greater than a first fraction of the first wavelength.

In another embodiment, a method of producing audible sound regions is provided. The method includes delivering a plurality of signals to a driver coupled to a cabinet. The cabinet includes a body having an internal surface and an external surface. An internal region of the cabinet is at least partially enclosed by the internal surface of the body. A first port and a second port are formed in the body. The first port is positioned at a first end of the cabinet and the second port is positioned at a second end of the cabinet. The first port includes a first opening in which a plurality of positive sound waves generated by the driver are emitted into an external region. The second port includes a second opening in which a plurality of negative sound waves generated by the driver are emitted into the external region. The cabinet includes a cabinet length that extends from the first end to the second end. The plurality of signals delivered to the driver cause the driver to generate the plurality of positive sound waves that are provided to the first port and the plurality of negative sound waves that are delivered to the second port at frequencies less than a first frequency corresponding to a first wavelength.

In yet another embodiment, a listening environment is provided. The listening environment includes an enclosure, a driver coupled to a body of the enclosure, a first audible sound region located within a first portion of an exterior region positioned outside of the enclosure and adjacent to the first end of the enclosure, a second audible sound region located within a second portion of the exterior region and adjacent to the second end of the enclosure, and an inaudible sound region located between the first portion and the second portion of the exterior region. The enclosure includes a body having an internal surface and an external surface. The internal region of the cabinet is at least partially enclosed by the internal surface of the body. The enclosure further includes a first port and a second port formed in the body. The first port is positioned at a first end of the cabinet and the second port is positioned at a second end of the cabinet. The first port includes a first opening in which a plurality of positive sound waves generated by the driver are emitted into an external region. The second port includes a second opening in which a plurality of negative sound waves generated by the driver are emitted into the external region. The driver produces the plurality of positive sound waves in a direction towards the first end of the enclosure and produces the plurality of negative sound waves in a direction towards the second end of the enclosure. The plurality of positive sound waves and the plurality of negative sound waves each comprise a first frequency that has a first wavelength. A sound pressure level (SPL) measured at the first frequency within the first portion and the second portion exceeds a first sound pressure level (SPL). A sound pressure level (SPL) measured at the first frequency within the inaudible sound region is less than the first sound pressure level (SPL).

Embodiments of the disclosure include a speaker assembly, comprising a waveguide and a driver is coupled to the waveguide. The waveguide includes a first sound opening positioned at a first end of the waveguide, a second sound opening positioned at a second end of the waveguide, and an internal region that extends between the first sound opening and the second sound opening. The driver comprises a diaphragm that separates a first portion of the internal region disposed on a first side of the driver from a second portion of the internal region disposed on a second side of the driver, and wherein a cross-sectional area at any point along a length of the first portion of the internal region that extends from the first side of the driver to the first opening is at least 80% of the area of the driver.

Embodiments of the disclosure include a speaker assembly, comprising a waveguide and a driver is coupled to the waveguide. The waveguide includes a first sound opening positioned at a first end of the waveguide, a second sound opening positioned at a second end of the waveguide, and an internal region that extends between the first sound opening and the second sound opening. The driver comprises a diaphragm that fluidly isolates a first portion of the internal region disposed on a first side of the driver from a second portion of the internal region disposed on a second side of the driver, and wherein a cross-sectional area at any point along a length of the first portion of the internal region that extends from the first side of the driver to the first opening is at least 80% of the area of the driver.

Embodiments of the disclosure include a speaker assembly, comprising a waveguide and a driver is coupled to the waveguide. The waveguide comprises a first sound opening positioned at a first end of the waveguide, a second sound opening positioned at a second end of the waveguide, and an internal region that extends between the first sound opening and the second sound opening. The driver is coupled to the waveguide, wherein the driver comprises a diaphragm that separates a first portion of the internal region disposed on a first side of the driver from a second portion of the internal region disposed on a second side of the driver, and wherein a length of the first portion of the internal region that extends between the first side of the driver and the first opening is at least 0.4 meters long.

Embodiments of the disclosure include a method of generating an audible sound, comprising: generating an audible sound from a speaker assembly, wherein the speaker assembly comprises: a waveguide comprising: a first sound opening positioned at a first end of the waveguide; and a second sound opening positioned at a second end of the waveguide; and a driver coupled to the waveguide, wherein the driver comprises a diaphragm that separates an internal region of the waveguide disposed on a first side of the driver from a second side of the driver, and wherein a sound pressure level (SPL) of the generated audible sound decreases by an amount greater than the inverse square law as a distance from the first sound opening or the second sound opening increases. The method can further comprise: coupling the waveguide to a supporting element of a supporting structure, wherein coupling the waveguide to the supporting element comprises positioning the first sound opening or the second sound opening so that a head of a user, which is disposed on the supporting element, is at or within one meter from the first sound opening or second sound opening.

Embodiments of the disclosure include a method of generating an audible sound, comprising: generating an audible sound from a speaker assembly at frequencies less than 200 Hz, wherein the speaker assembly comprises: a waveguide comprising: a first sound opening positioned at a first end of the waveguide; and a second sound opening positioned at a second end of the waveguide; and a driver coupled to the waveguide, wherein the driver comprises a diaphragm that separates an internal region of the waveguide disposed on a first side of the driver from a second side of the driver, and wherein the frequencies of the generated audible sound comprise at least a first frequency, and a length of the internal region, which extends between the first side of the driver and the first opening, is at least a quarter wavelength of the first frequency.

Embodiments of the disclosure include a method of generating an audible sound, comprising: generating an audible sound from a speaker assembly into a listening environment, wherein the speaker assembly comprises: a waveguide comprising: a first sound opening positioned at a first end of the waveguide; a second sound opening positioned at a second end of the waveguide; and an internal region that extends between the first sound opening and the second sound opening; and a driver coupled to the waveguide, wherein the driver comprises a diaphragm that separates a first portion of the internal region disposed on a first side of the driver from a second portion of the internal region disposed on a second side of the driver, and wherein the generated audible sound comprises frequencies no greater than 200 Hz, and the audible sound generated by the driver causes the driver to generate positive sound waves that are provided to the listening environment from the first side of the driver and negative sound waves that are provided to the listening environment from the second side of the driver, and the magnitude of the sound pressure level (SPL) of the positive sound waves and negative sound waves exiting the speaker assembly into the listening environment are about equal when they exit the speaker assembly.

Embodiments of the disclosure include a method of generating an audible sound, comprising: generating an audible sound from a speaker assembly into a listening environment, wherein generating the audible sound comprises: delivering from a first sound-generating source a first portion of the audible sound to the listening environment; delivering from a second sound generating source a second portion of the audible sound to the listening environment, wherein the generated audible sound comprises frequencies no greater than 200 Hz, and the magnitude of the sound pressure level (SPL) of the first portion of the audible sound when exiting the first sound generating source into the listening environment is about equal to the magnitude of the SPL of the second portion of the audible sound when exiting the second sound generating source into the listening environment.

Embodiments of the disclosure include a method of generating an audible sound, comprising: generating an audible sound from a speaker assembly into a listening environment, wherein the generated audible sound comprises: positive sound waves and negative sound waves that are within a frequency range that is no greater than 200 Hz; and generating the audible sound further comprises: delivering, by a first sound-generating source, the positive sound waves to the listening environment; and delivering, by a second sound-generating source, the negative sound waves to the listening environment, wherein the magnitude of the sound pressure level (SPL) of the positive sound waves exiting the speaker assembly into the listening environment is substantially equal to the magnitude of the SPL of the negative sound waves exiting the speaker assembly into the listening environment.

Embodiments of the disclosure include a speaker assembly that comprises a waveguide and a driver coupled to the waveguide. The waveguide comprises a first sound opening positioned at a first end of the waveguide; and a second sound opening positioned at a second end of the waveguide. The driver is coupled to the waveguide, and is positioned at the second end of the waveguide, wherein the driver comprises a diaphragm that separates an internal region of the waveguide disposed on a first side of the driver from an external region disposed on a second side of the driver, the external region is located outside of the waveguide, and the internal region includes a length that extends between the first side of the driver and the first sound opening, and wherein a cross-sectional area at any point along the length of the internal region is at least 80% of the area of the driver.

Embodiments of the disclosure include a speaker assembly that comprises a waveguide and a driver coupled to the waveguide. The waveguide comprises: a first sound opening positioned at a first end of the waveguide; and a second sound opening positioned at a second end of the waveguide. The driver is positioned at the second end of the waveguide, wherein the driver comprises a diaphragm that separates an internal region of the waveguide disposed on a first side of the driver from an external region disposed on a second side of the driver, the external region is located outside of the waveguide, the driver is configured to deliver sound waves at least at a first frequency that is less than 200 Hz and has a first wavelength, the internal region includes a length that extends between the first side of the driver and the first sound opening, and the length of the internal region is at least greater than a quarter (¼) of the first wavelength.

Embodiments of the disclosure include a speaker assembly that comprises a waveguide and a driver coupled to the waveguide. The waveguide comprises: a first sound opening positioned at a first end of the waveguide; a second sound opening positioned at a second end of the waveguide; and an internal region that extends between the first sound opening and the second sound opening. The driver comprises a diaphragm that separates a first portion of the internal region disposed on a first side of the driver from a second portion of the internal region disposed on a second side of the driver, wherein the distance between the center point of the first sound opening and the center point of the second sound opening is at least 0.4 meters.

Embodiments of the disclosure include a speaker assembly comprising a waveguide, a driver coupled to the waveguide, and a supporting structure. The waveguide comprises: a first sound opening positioned at a first end of the waveguide; a second sound opening positioned at a second end of the waveguide; and an internal region that extends between the first sound opening and the second sound opening. The driver comprises a diaphragm that separates a first portion of the internal region disposed on a first side of the driver from a second portion of the internal region disposed on a second side of the driver. The supporting structure comprises a supporting element that is configured to support a portion of a user, wherein the waveguide is coupled to the supporting structure through a coupling.

Embodiments of the disclosure include a speaker assembly comprising a waveguide, a driver coupled to the waveguide, and a supporting structure. The waveguide comprises: a first sound opening positioned at a first end of the waveguide; a second sound opening positioned at a second end of the waveguide; and an internal region that extends between the first sound opening and the second sound opening. The driver comprises a diaphragm that separates a first portion of the internal region disposed on a first side of the driver from a second portion of the internal region disposed on a second side of the driver, wherein a cross-sectional area at any point along a length of the first portion of the internal region that extends from the first side of the driver to the first sound opening is at least 80% of the area of the driver. The supporting structure comprises a supporting element that is configured to support a portion of a user, wherein the waveguide is coupled to the supporting structure through a coupling.

Embodiments of the disclosure include a method of generating an audible sound, comprising: generating haptic vibrations from a speaker assembly at frequencies less than 200 Hz, wherein the speaker assembly comprises: a waveguide comprising: a first sound opening positioned at a first end of the waveguide; and a second sound opening positioned at a second end of the waveguide; and a driver coupled to the waveguide, wherein the driver comprises a diaphragm that separates an internal region of the waveguide disposed on a first side of the driver from a second side of the driver, and wherein the frequencies of the generated haptic vibrations comprise at least a first frequency, and a length of the internal region, which extends between the first side of the driver and the first opening, is at least a quarter wavelength of the first frequency, and, a cross-sectional area of the second sound opening is at least 80% of a cross-sectional area of the first sound opening.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A illustrates an audio driver that is suspended in air and is being actively driven.

FIG. 1B illustrates a conventional speaker assembly that is a ported enclosure that includes a low frequency driver that is being actively driven.

FIG. 2A illustrates a dipole speaker assembly, according to one or more embodiments of the disclosure.

FIG. 2B illustrates a dipole speaker assembly including telescoping sections in an expanded form.

FIG. 2C illustrates a dipole speaker assembly including telescoping sections in a collapsed form.

FIG. 3A illustrates a dipole speaker assembly including a driver positioned near the middle of the cabinet, according to one or more embodiments of the disclosure.

FIG. 3B illustrates a dipole speaker assembly including a driver positioned between the middle of the cabinet and a second end of the cabinet, according to one or more embodiments of the disclosure.

FIG. 3C illustrates a dipole speaker assembly including a driver positioned near a second end of the cabinet, according to one or more embodiments of the disclosure.

FIGS. 3D-3F illustrate multiple configurations of a dipole speaker assembly with varying cabinet lengths, according to one or more embodiments of the disclosure.

FIG. 3G is a diagram illustrating a decrease in SPL as a function of distance according to the inverse square law and a decrease in SPL as a function of distance when using one or more embodiments of the disclosure provided herein.

FIG. 4A illustrates a dipole speaker assembly coupled to a chair, according to one or more embodiments of the disclosure.

FIG. 4B illustrates a dipole speaker assembly coupled to a chair, the chair having feet that decrease in width, according to one or more embodiments of the disclosure.

FIG. 4C illustrates a dipole speaker assembly coupled to a chair, the chair having a base extending to the ground, according to one or more embodiments of the disclosure.

FIG. 4D illustrates a dipole speaker assembly coupled to a chair, the chair having a base with a plurality of legs extending to the ground, according to one or more embodiments of the disclosure.

FIG. 4E illustrates a dipole speaker assembly coupled to a chair, the dipole speaker assembly having a horizontal section, according to one or more embodiments of the disclosure.

FIG. 5 illustrates a stand assembly including a dipole speaker assembly, according to one or more embodiments of the disclosure.

FIG. 6A illustrates a side view of the cross-section of a dipole speaker assembly including a top port with a first cross-sectional area and a bottom port with a second cross sectional area, according to one or more embodiments of the disclosure.

FIG. 6B illustrates a top view of the cross-section of a dipole speaker assembly including a top port with a first cross-sectional area and a bottom port with a second cross sectional area, according to one or more embodiments of the disclosure.

FIG. 6C illustrates a bottom view of the cross-section of a dipole speaker assembly including a top port with a first cross-sectional area and a bottom port with a second cross sectional area, according to one or more embodiments of the disclosure.

FIG. 6D illustrates a simulated free-field sound pressure level map from a top-down perspective of a dipole speaker assembly including a top port with a first cross-sectional area and a bottom port with a second cross sectional area, according to one or more embodiments of the disclosure.

FIG. 6E illustrates a simulated free-field sound pressure level map from a side perspective of a dipole speaker assembly including a top port with a first cross-sectional area and a bottom port with a second cross sectional area, according to one or more embodiments of the disclosure.

FIGS. 7A-7C illustrate perspective views of a dipole speaker assembly including an angled top port, according to one or more embodiments of the disclosure.

FIG. 7D illustrates a perspective view of a dipole speaker assembly including an angled top port, the dipole speaker assembly mounted to a chair, according to one or more embodiments of the disclosure.

FIG. 7E illustrates a perspective side view of a dipole speaker assembly including an angled top port, the dipole speaker assembly mounted to a chair, according to one or more embodiments of the disclosure.

FIG. 7F illustrates a side view of the cross-section of a dipole speaker assembly including an angled top port, according to one or more embodiments of the disclosure.

FIG. 7G illustrates a front view of the cross-section of an angled top port of a dipole speaker assembly, according to one or more embodiments of the disclosure.

FIG. 7H illustrates a bottom view of the cross-section of a dipole speaker assembly including an angled top port, according to one or more embodiments of the disclosure.

FIG. 7I illustrates a simulated free-field sound pressure level map from a top-down perspective of a dipole speaker assembly including an angled top port, according to one or more embodiments of the disclosure.

FIG. 7J illustrates a simulated free-field sound pressure level map from a side perspective of a dipole speaker assembly including an angled top port, according to one or more embodiments of the disclosure.

FIG. 8A illustrates a simulated free-field sound pressure level map from a top-down perspective of a dipole speaker assembly including an angled top port with two openings, according to one or more embodiments of the disclosure.

FIG. 8B illustrates a simulated free-field sound pressure level map from a side perspective of a dipole speaker assembly including an angled top port with two openings, according to one or more embodiments of the disclosure.

FIG. 8C illustrates a simulated free-field sound pressure level map from a top-down perspective of a dipole speaker assembly including an angled top port with an inlaid opening within the top port, according to one or more embodiments of the disclosure.

FIG. 9A illustrates a dipole speaker assembly positioned near an intended listener in an environment with a number of other unintended listeners, according to one or more embodiments of the disclosure.

FIG. 9B illustrates a simulated sound pressure level field map within a semi-reverberant enclosed environment including a conventional sealed speaker assembly operating at a frequency of 30 Hz positioned on one side of the environment.

FIG. 9C illustrates a simulated sound pressure level field map within a semi-reverberant enclosed environment including a dipole speaker assembly operating at a frequency of 30 Hz positioned on one side of the environment, according to one or more embodiments of the disclosure.

FIG. 9D illustrates a simulated sound pressure level field map within a semi-reverberant enclosed environment including a conventional sealed speaker assembly operating at a frequency of 60 Hz positioned on one side of the environment.

FIG. 9E illustrates a simulated sound pressure level field map within a semi-reverberant enclosed environment including a dipole speaker assembly operating at a frequency of 60 Hz positioned on one side of the environment, according to one or more embodiments of the disclosure.

FIG. 9F illustrates a simulated sound pressure level field map within a semi-reverberant enclosed environment including a conventional sealed speaker assembly operating at a frequency of 80 Hz positioned on one side of the environment.

FIG. 9G illustrates a simulated sound pressure level field map within a semi-reverberant enclosed environment including a dipole speaker assembly operating at a frequency of 80 Hz positioned on one side of the environment, according to one or more embodiments of the disclosure.

FIG. 10A illustrates the correlation between the operating frequency and the magnitude of sound waves produced by a conventional sealed speaker assembly measured at various distances from the conventional sealed subwoofer assembly in a qualified anechoic chamber.

FIG. 10B illustrates the data of FIG. 10A normalized to emphasize the difference in correlations of the measurements at various distances.

FIG. 11A illustrates the correlation between the operating frequency and the magnitude of sound waves produced by a dipole speaker assembly measured at various distances from the dipole speaker assembly in a qualified anechoic chamber, according to one or more embodiments of the disclosure.

FIG. 11B illustrates the data of FIG. 11A normalized to emphasize the difference in correlations of the measurements at various distances.

FIG. 12A illustrates the correlation between the operating frequency and the magnitude of sound waves produced by a dipole speaker assembly including an angled top port measured at various distances from the dipole speaker assembly in a qualified anechoic chamber, according to one or more embodiments of the disclosure.

FIG. 12B illustrates the data of FIG. 12A normalized to emphasize the difference in correlations of the measurements at various distances.

FIG. 13A illustrates a sound pressure level map of a conventional sealed speaker assembly operating at various frequencies, and measurements observed around the conventional sealed speaker assembly at a radius of 0.1 m away from the conventional sealed speaker assembly in a qualified anechoic chamber, according to one or more embodiments of the disclosure.

FIG. 13B illustrates a sound pressure level map of a conventional sealed speaker assembly operating at various frequencies, and measurements observed around the conventional sealed speaker assembly at a radius of 0.5 m away from the conventional sealed speaker assembly in a qualified anechoic chamber, according to one or more embodiments of the disclosure.

FIG. 13C illustrates a sound pressure level map of a conventional sealed speaker assembly operating at various frequencies, and measurements observed around the conventional sealed speaker assembly at a radius of 1 m away from the conventional sealed speaker assembly in a qualified anechoic chamber, according to one or more embodiments of the disclosure.

FIG. 13D illustrates a sound pressure level map of a conventional sealed speaker assembly operating at various frequencies, and measurements observed around the conventional sealed speaker assembly at a radius of 2 m away from the conventional sealed speaker assembly in a qualified anechoic chamber, according to one or more embodiments of the disclosure.

FIG. 14A illustrates a sound pressure level map of a dipole speaker assembly operating at various frequencies, and measurements observed around the dipole speaker assembly at a radius of 0.1 m away from the dipole speaker assembly in a qualified anechoic chamber, according to one or more embodiments of the disclosure.

FIG. 14B illustrates a sound pressure level map of a dipole speaker assembly operating at various frequencies, and measurements observed around the dipole speaker assembly at a radius of 0.5 m away from the dipole speaker assembly in a qualified anechoic chamber, according to one or more embodiments of the disclosure.

FIG. 14C illustrates a sound pressure level map of a dipole speaker assembly operating at various frequencies, and measurements observed around the dipole speaker assembly at a radius of 1 m away from the dipole speaker assembly in a qualified anechoic chamber, according to one or more embodiments of the disclosure.

FIG. 14D illustrates a sound pressure level map of a dipole speaker assembly operating at various frequencies, and measurements observed around the dipole speaker assembly at a radius of 2 m away from the dipole speaker assembly in a qualified anechoic chamber, according to one or more embodiments of the disclosure.

FIG. 15A illustrates a sound pressure level map of a dipole speaker assembly including an angled top port operating at various frequencies, and measurements observed around the dipole speaker assembly at a radius of 0.1 m away from the dipole speaker assembly in a qualified anechoic chamber, according to one or more embodiments of the disclosure.

FIG. 15B illustrates a sound pressure level map of a dipole speaker assembly including an angled top port operating at various frequencies, and measurements observed around the dipole speaker assembly at a radius of 0.5 m away from the dipole speaker assembly in a qualified anechoic chamber, according to one or more embodiments of the disclosure.

FIG. 15C illustrates a sound pressure level map of a dipole speaker assembly including an angled top port operating at various frequencies, and measurements observed around the dipole speaker assembly at a radius of 1 m away from the dipole speaker assembly in a qualified anechoic chamber, according to one or more embodiments of the disclosure.

FIG. 15D illustrates a sound pressure level map of a dipole speaker assembly including an angled top port operating at various frequencies, and measurements observed around the dipole speaker assembly at a radius of 2 m away from the dipole speaker assembly in a qualified anechoic chamber, according to one or more embodiments of the disclosure.

FIG. 16A illustrates a side view of a dipole speaker assembly that is positioned to provide audible sound to two locations that are configured to support two users during the delivery of sound by a driver, according to one or more embodiments of the disclosure.

FIG. 16B illustrates a front view of a dipole speaker assembly that is positioned to provide audible sound to two or more locations, according to one or more embodiments of the disclosure.

FIG. 16C illustrates a side view of a dipole speaker assembly that is positioned to provide audible sound region to two or more locations and includes additional channels, according to one or more embodiments of the disclosure.

FIG. 17 illustrates a dipole speaker assembly coupled to an auxiliary speaker assembly, according to one or more embodiments of the disclosure.

FIG. 18 illustrates two dipole speaker assemblies coupled to a mounting device, according to one or more embodiments of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

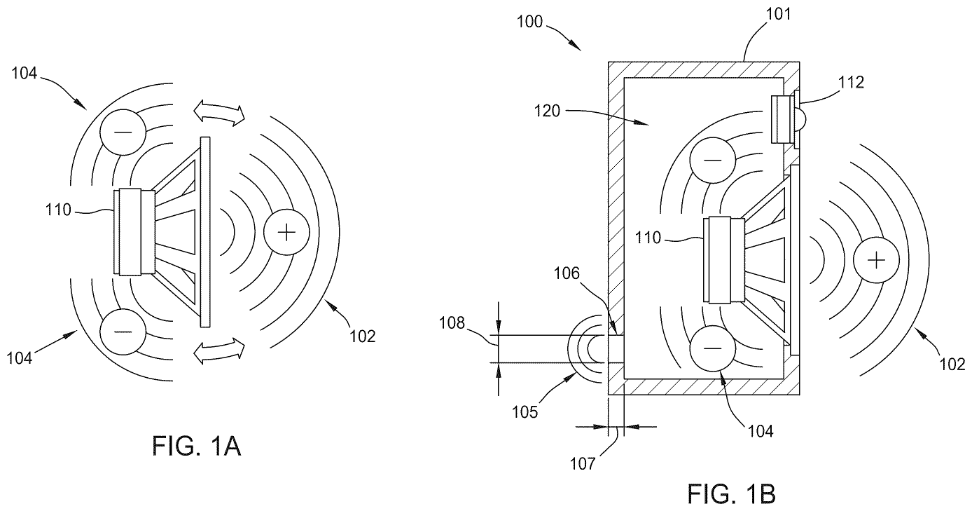

The following disclosure describes systems, methods, and apparatuses that are configured to control the delivery of acoustically generated sound waves to desired areas within an environment and/or limit the extent by which acoustically generated sound waves are transmitted to other areas outside of the desired areas of the environment. In some embodiments, systems, methods, and apparatuses can be used to control the extent that sound waves produced by a speaker assembly are provided to an environment. Certain details are set forth in the following description and in FIGS. 1A-18 to provide a thorough understanding of various implementations of the disclosure.

Many of the details, dimensions, angles, and other features shown in the Figures are merely illustrative of particular implementations. Accordingly, other implementations can have other details, components, dimensions, angles, and features without departing from the spirit or scope of the present disclosure. In addition, further implementations of the disclosure can be practiced without several of the details described below.

Embodiments of the disclosure provided herein generally relate to a dipole speaker assembly. The dipole speaker assembly may be positioned on a structural element within the environment that it is positioned within, such as a floor, a wall, or connected to a piece of furniture, such as a chair. When the dipole speaker assembly is operating and producing sound waves, some of the positive sound pressure waves traveling through one end of the dipole speaker assembly will interact with some of the negative sound pressure waves traveling through the other end of the dipole speaker assembly, creating an area where the sound waves produced by the dipole speaker assembly cancel out and thus cannot be perceived as an audible sound (e.g., heard by a user). Sound can be detected (e.g., heard or perceived as a haptic vibration) at areas near each end of the dipole speaker assembly because the sound pressure waves from each end do not strongly interact and therefore do not cancel each other out.

FIG. 1A illustrates a driver 110 that is suspended in air and is being driven by a signal provided by an electrical source. Positive sound waves 102 are emitted from the front side of the driver 110. These positive sound waves 102 are created when the driver 110 compresses air positioned on the front side of the driver due to the movement of a diaphragm that creates positive sound pressure waves that propagate through the air surrounding the driver 110. Similarly, sound waves 104 are emitted at the rear side of the driver 110 due to the same movement of the diaphragm. As a result, negative sound pressure waves 104 are created in the air on an opposite end of the driver 110. Consequently, negative sound waves 104 of equivalent magnitude to the positive sound waves 102 are emitted from the opposite end of the driver 110. Due to the negative sound waves 104 being 180 degrees out of phase with the positive sound waves 102 (i.e., both being emitted by the same movement of the diaphragm), and direct exposure of the positive sound waves 102 to the negative sound waves 104, the generated waves will cancel each other out and no audible sound is generated by the driver 110.

In an effort to efficiently deliver audible sounds and/or minimize the cancellation of at least a portion of one of the generated sound waves (i.e., positive sound waves 102 or negative sound waves 104), drivers are typically installed in an enclosure, such as a cabinet 101 illustrated in FIG. 1B. FIG. 1B illustrates an at least partially sealed conventional speaker assembly 100 (i.e., often referred to as a ported enclosure) that includes a driver 110 and another driver 112 operating at a different frequency such as a midrange speaker or a tweeter. A midrange speaker is a speaker including a driver that operates within a range of midrange frequencies. A range of midrange frequencies may be between 300 Hz and 5,000 Hz. A tweeter is a speaker including a driver that operates within a range of high frequencies. A range of high frequencies may be between 2,000 Hz and 20,000 Hz. The speaker assembly 100 manipulates the direction and/or extent in which the negative sound waves 104 travel so as to not interfere with the positive sound waves 102. The direction of the negative sound waves 104 is manipulated to control or limit where the positive sound waves 102 and negative sound waves 104 interact to create zones where no audible sound can be heard. In this configuration, the negative sound waves 104 are prevented from directly entering the external environment surrounding the speaker assembly 100 after being emitted from the backside of the driver, since they are emitted into an internal region 120 of a cabinet 101 of the speaker assembly 100. The negative sound waves 104 may remain in the internal region 120 as the speaker assembly 100 operates. However, in some configurations, the sound waves generated in the internal region 120 are provided an exit path, such as an exit port 106 formed in the cabinet 101, to tune the frequency spectrum that is perceived by a user during the generation of sound by the conventional speaker assembly 100. In this case, the sound waves generated in internal region 120 will be emitted through the port 106. To avoid the direct interaction of the positive sound waves 102 and the negative sound waves 104, as illustrated in FIG. 1A, the port 106 will typically be provided as a small opening within the cabinet 101. The sound waves that are emitted through the port 106 (i.e., ported sound waves 105) will limit the frequency range that is perceived by a user during the generation of sound by the driver 110. The frequency range detected by a user can be tuned by controlling the frequencies (i.e., wavelengths) generated by the driver 110, the size of the internal region 120, the length 108 of the port 106, and the depth 107 of the port 106. The locations at which the positive sound waves 102 and the ported sound waves 105 interact in the external environment is generally not controlled and thus sound pressure levels (SPLs) experienced within the external environment surrounding the cabinet will vary in unknown and undesirable ways.

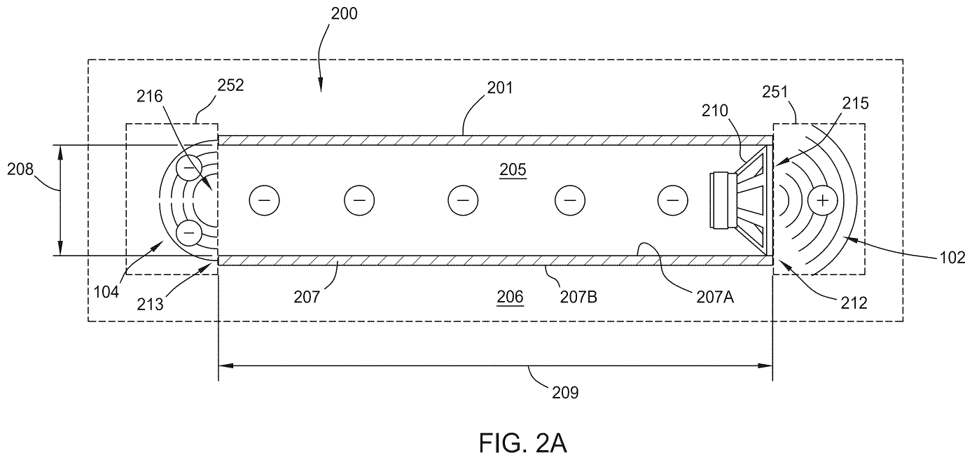

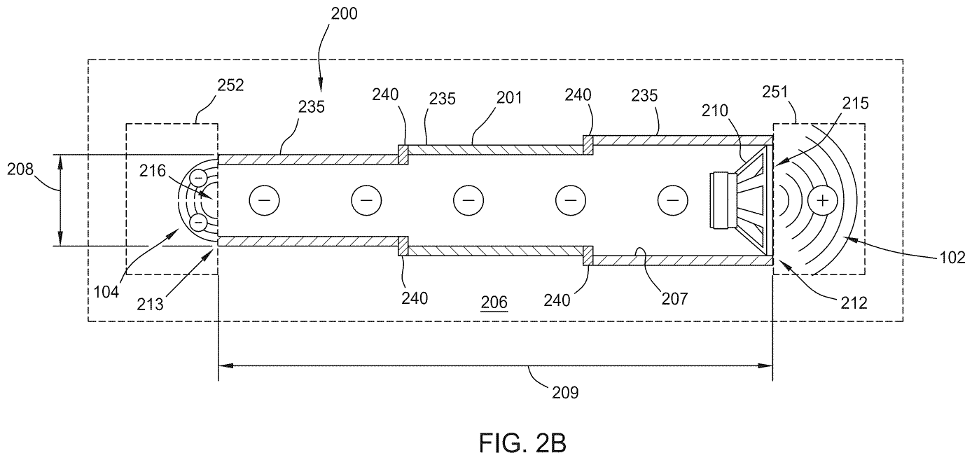

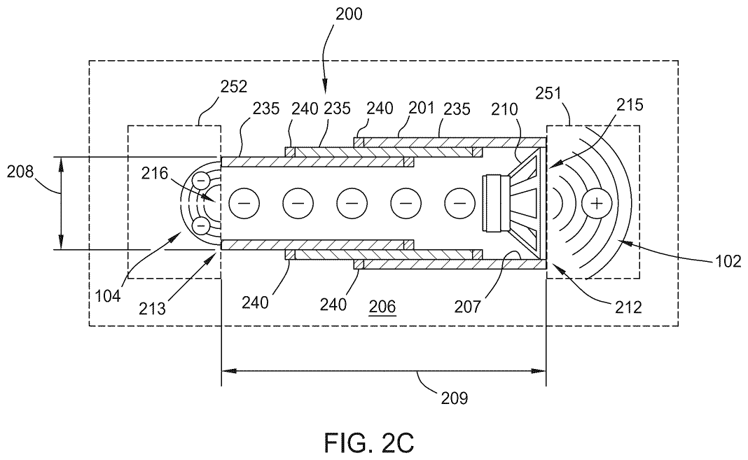

FIG. 2A illustrates an example of a dipole speaker assembly 200 that solves the problems described above. The dipole speaker assembly 200 includes an acoustic waveguide, or simply waveguide, that includes an extended cabinet with a driver 210 positioned within a portion of the extended cabinet. The waveguide, which is commonly referred to herein as a cabinet 201, is configured to guide the sound waves generated by the driver 210 and control the generated sound wave direction and radiation pattern. The cabinet 201 will include a body 207 (e.g., wall of the waveguide) which separates an internal region 205 of the waveguide from an external region 206 of the waveguide. The driver 210 may comprise a diaphragm that separates a first side of the driver 210 from a second side of the driver 210. The driver 210 may be sealably coupled to the body 207 so that at least a portion of the internal region 205 disposed on the first side of the driver 210 is fluidly isolated from the second side of the driver 210.

In one or more embodiments, the body 207 is made of a solid material. In one or more embodiments, the body 207 includes a solid material enclosing a center portion. The center portion may be hollow such that it is filled with air. In one or more embodiments, the body 207 is made of a flexible, low density material such as carbon fiber, fiberglass, or a combination thereof. The density of the material can be increased to limit the movement and/or alter the resonance frequencies of the cabinet 201 when the driver 210 is activated. For example, the body 207 may be made of a material that has a higher stiffness (i.e., Young's Modulus) than various plastic or composite materials, such as medium-density fiberboard (MDF) that can have, for example, a Young's Modulus of about 4 GPa.

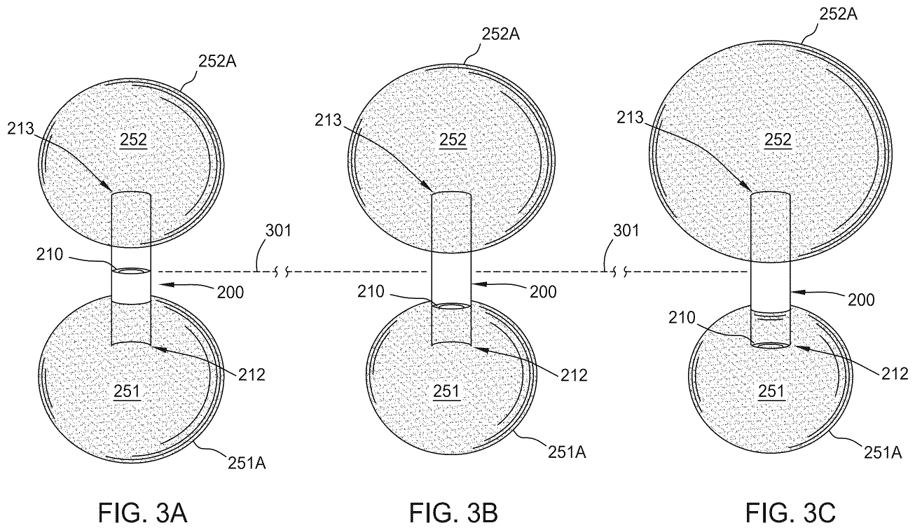

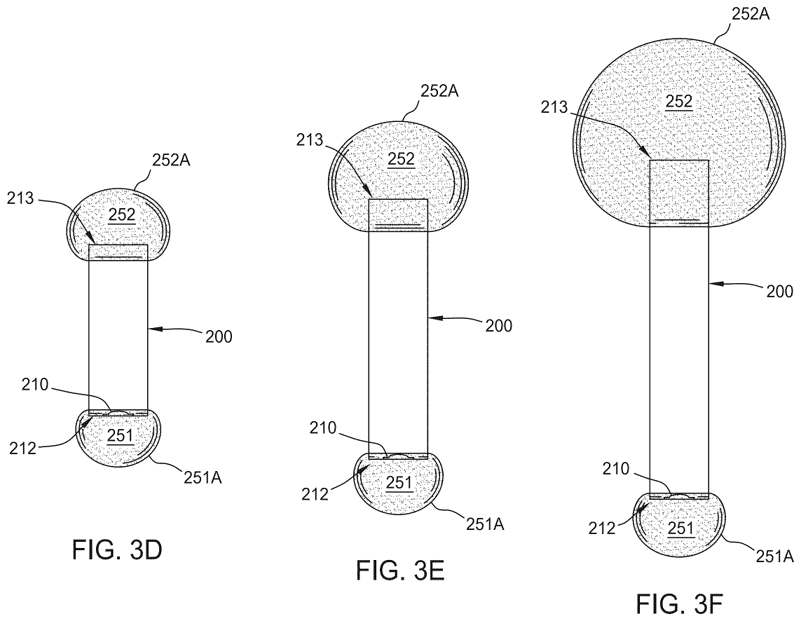

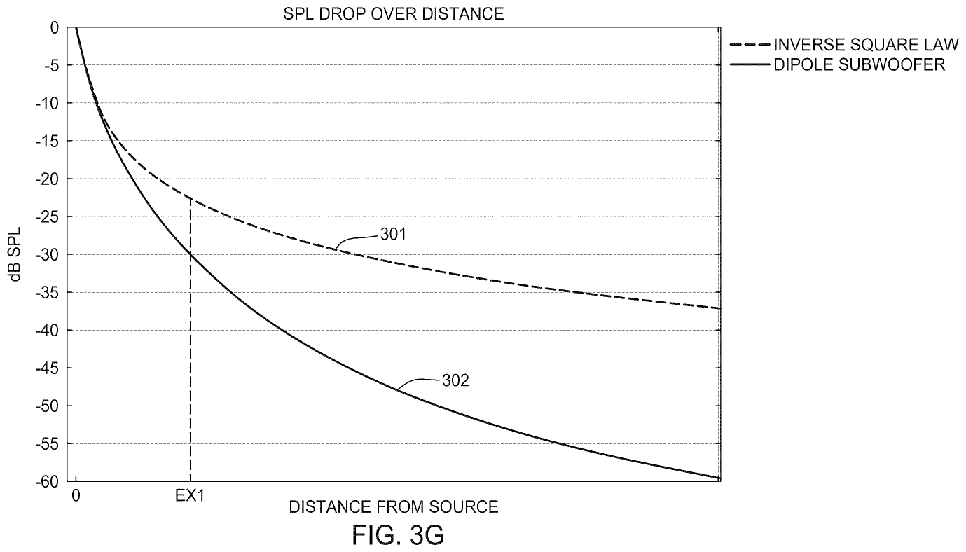

The driver 210 may be a subwoofer driver that is configured to operate within a sound frequency range between 10 Hz and 400 Hz, such as between 20 Hz and 200 Hz, or even between 20 Hz and 100 Hz, or between 20 Hz and 80 Hz. However, in some configurations, an audio signal provided to a driver 210 from a signal source is configured to cause the driver 210 to only emit sound waves at frequencies less than a first frequency, such as a first frequency that is less than 200 Hz, or less than 100 Hz, or emit sound waves at frequencies within a desired frequency range, such as a range between 10 Hz and 400 Hz, or between 20 Hz and 200 Hz, or even between 20 Hz and 100 Hz. In one or more embodiments, the cabinet 201 is a tube including a first port 215 at a first end 212, in which positive sound waves 102 emit from an opening of the first port 215 into a first audible region, or first exterior region, 251. The cabinet 201 also includes a second port 216 at a second end 213, in which negative sound waves 104 emit from an opening of the second port 216 into a second audible region, or second exterior region, 252. Outside of the first audible region 251 and the second audible region 252, the positive sound waves 102 will interact with the negative sound waves 104 and cause the perceived or detected sound pressure level of the generated sound waves by the driver 210 to decrease dramatically due to the superposition of the interacting positive sound waves 102 and negative sound waves 104. Accordingly, a user may be positioned proximate to the driver 210 so the user may hear the generated sound waves without experiencing the significant sound pressure level (SPL) roll-off, which occurs as a function of distance from the port at the end of the cabinet 201 (See curve 302 in FIG. 3G). More specifically, the user may be positioned proximate to either the first end 212 or the second end 213 within either the first audible region 251 or the second audible region 252. In one example, by use of a supporting structure, a head region of a user (e.g., at least one ear of the user) is positioned at the edge of or within the second audible region 252 that includes an envelope (e.g., spherical region) that is a first distance from the second port 216 positioned at the second end 213 of the cabinet 201. In one example, the first distance can be between zero millimeters (mm) and 1 meter (m), such as between 1 millimeter (mm) and 0.5 meters (m), or between 1 mm and 0.4 m, or between 1 mm and 0.3 m, or between 1 mm and 0.2 m, or even between 1 mm and 0.1 m.

In FIGS. 3A-3F, the size of the first audible region 251 is illustrated by a first constant sound pressure level region 251A in which the positive sound waves 102 have a detectable sound pressure level (SPL). Similarly, the second audible region 252 is illustrated by a second constant sound pressure level region 252A in which the negative sound waves 104 have a detectable SPL. For ease of discussion and comparison purposes, the first constant sound pressure level region 251A and the second constant sound pressure level region 252A are regions that include an SPL therein that is at least as large as the SPL at the surface or outer edge of the region. Thus, a first person or first SPL detector positioned along the edge of the envelope of the region, illustrated by the first constant sound pressure level region 251A or the second constant sound pressure level region 252A, would experience sound waves at a desired frequency that have the same SPL throughout the region. A second user or second SPL detector positioned inside a region would experience a higher SPL.

FIG. 3A illustrates the constant sound pressure level regions 251A, 252A of audible sound produced from a dipole speaker assembly 200 with a driver 210 positioned in the middle point (i.e., see mid-line 301) of the cabinet 201. In this embodiment, the driver 210 is facing towards the first end 212 of the cabinet 201, so that the positive sound waves 102 travel down and create a first constant sound pressure level region 251A near the first end 212 of the cabinet 201. In some embodiments, the driver 210 is facing towards the second end 213 of the cabinet 201, so that the positive sound waves 102 travel up and create a first constant sound pressure level region 252A near the second end 213 of the cabinet 201.

Sound pressure level is constant along the boundaries of the first audible sound region 251 and the second audible sound region 252. The sound pressure level increases the closer a listening user is positioned towards either the opening of the first port 215 or the opening of the second port 216. The sound pressure level decreases the further a listening user is positioned away from either of these openings. The sound pressure level drastically decreases outside the boundaries of both the first audible sound region 251 and the second audible sound region 252. In several locations outside of the boundaries of both the first audible sound region 251 and the second audible sound region 252, the sound pressure level is so low that the locations can be considered inaudible sound regions.

FIG. 3G is a diagram illustrating a decrease in SPL as a function of distance according to the inverse square law (i.e., curve 301) and a decrease in SPL as a function of distance (i.e., curve 302) when using an embodiment of the disclosure provided herein. FIG. 3G compares the SPL decrease in the dipole speaker assembly 200 with the inverse square law, which is often used in conventional applications to predict the magnitude of radiation (e.g., SPL) as a detector is moved further away from the source of radiation. The SPL decrease in the dipole speaker assembly 200, as illustrated in FIG. 3G, is plotted based on a sound detector that is positioned along a line that extends from the opening of the first port 215 or the opening of the second port 216 at a single angle. The inverse square law for acoustic applications can be defined as the sound pressure of a spherical wavefront radiating from a point source will decrease by 50% as the distance r from the source is doubled, which if measured in decibels (dB), will equal a decrease of about 6.02 dB each time the distance is doubled. In acoustic applications the inverse square law can be summarized by the relationship p∝1/r, where p is equal to pressure and r is the distance from the acoustic source. As illustrated by FIG. 3G, the dipole speaker assembly 200 produces an SPL roll-off at a level that is significantly greater than the SPL roll-off that is predicted by the inverse square law. Due to the configuration of the dipole speaker assembly 200 disclosed herein, and as illustrated in FIG. 3G, the SPL roll-off for the dipole speaker is always equal to or greater than the SPL roll-off that is predicted by the inverse square law. In one example, the difference in the predicted SPL by a conventional speaker, which due to its design configuration, will follow the inverse square law curve 301 and the SPL generated by the dipole speaker assembly 200 (i.e., curve 302), as measured at a distance of about 1 meter from the output of the devices (see line EX1 in FIG. 3G) is about 8 decibels (dB). One skilled in the art will appreciate that the SPL drop seen across all possible angles of exposure within an environment in which the dipole speaker assembly 200 is disposed will provide a much greater SPL overall difference than would be experienced by a user positioned at the same distance across all angles from a conventionally designed speaker that follows the inverse square law prediction.

Additionally, in some embodiments the position of the driver 210 within the cabinet 201 is changed, as can be seen in FIGS. 3B-3C. FIG. 3B illustrates a driver 210 positioned between the middle of the cabinet 201 and the first end 212. FIG. 3C illustrates a driver 210 positioned near the first end 212 of the cabinet 201. These figures illustrate that as the driver 210 is positioned within the cabinet 201 towards the first end 212, the size of the first constant sound pressure level region 251A decreases while the size of the second constant sound pressure level region 252A increases.

Furthermore, the length 209 of the cabinet 201 also affects the size of the constant sound pressure level regions 251A, 252A. FIG. 3D illustrates a dipole speaker assembly 200 with a driver 210 positioned near the first end 212 of the cabinet 201. FIG. 3E illustrates a dipole speaker assembly 200 similar to FIG. 3D, but includes a cabinet 201 of a greater length 209 than FIG. 3D. Similarly, FIG. 3F illustrates a dipole speaker assembly 200 including a cabinet 201 of a greater length 209 than FIG. 3E. These figures illustrate that as the length 209 of the cabinet 201 increases, the size of the first constant sound pressure level region 251A slightly increases and the size of the second constant sound pressure level region 252A significantly increases in relation to the amount the size of the first constant sound pressure level (SPL) region 251A increases. In some embodiments, the length of the cabinet 201 is at least a fraction of the wavelength of the audible sound that is to be generated by the driver 210. In some embodiments, the length 209 of the cabinet 201 is equivalent to at least a quarter of a wavelength (e.g., ¼ λ) of the audible sound that is to be generated by the driver 210. In one example, the length 209 of the cabinet 201 is equal to the length of at least a quarter of a wavelength for a driver 210 that is configured to provide sounds at wavelengths less than 200 Hz, such as a length 209 of about 0.4 meters (m) or greater. In another example, the length 209 of the cabinet 201 is at least a quarter of a wavelength for a driver 210 that is configured to provide sounds at wavelengths less than 100 Hz, such as a length 209 of about 1 m or greater. In some embodiments, the length 209 of the cabinet 201 is equal to the length of at least a quarter of a wavelength for a driver 210 that is configured to provide sounds at wavelengths less than 60 Hz, such as a length 209 of about 1.5 m or greater. It should be appreciated that the above lengths 209 examples for cabinets 201 are determined based on a set of testing parameters at about sea level and about 20 degrees Celsius (° C.). The dipole speaker assembly 200 may be positioned in different environments with different elevations, temperatures, pressures, and other conditions that may affect the performance of the dipole speaker assembly 200. Accordingly, the optimal range of frequencies that are produced from a dipole speaker assembly 200 may change depending on operating conditions.

In some embodiments, the cabinet 201 includes an internal region 205 that has an inner dimension 208 that is configured to receive the negative sound waves 104 generated by the driver 210. In some embodiments, the inner dimension 208 will not significantly vary along its length. In one example, the inner dimension 208 defines a substantially straight cylinder that has a constant diameter. In some embodiments, the cross-sectional shape of the cabinet 201 is not circular, such as a cross-sectional shape that is an oval, a rectangle, hexagon, or any other useful internal cross-section shape. In some embodiments, the cabinet 201 has a varying cross-sectional area along the length of the cabinet 201. In one example, the cabinet 201 has a circular shape at the first end 212 and an oval, slot, or rectangular shape at the opposing second end 213. In some embodiments, the cabinet 201 is not substantially straight and is curved. In some embodiments, the size of the opening (i.e., second port 216) defined by its “opening area” created at the second end 213 is substantially the same or greater than the cross-section area of the internal region 205 of the cabinet 201. In one example, the cross-sectional area of internal region 205 of the cabinet 201 for a cylindrical shaped cabinet design that has an internal diameter of 10 inches and has an opening diameter that is also 10 inches in size will both have the same cross-sectional area of about 78.5 in². Thus, a ratio of the opening area of the second port 216 and the cross-sectional area of the internal region 205 will be a 1:1 ratio for this cylindrical cabinet example. In general, the smaller the cross-sectional area of the cabinet 201 or opening at the second port 216, the higher the air speed within the internal region 205 of the cabinet 201 or similarly air speed at the second port 216. It is believed that if the air speed is too high (e.g., >17 m/s) the generated sound will appear distorted (i.e., create distortion) and possibly create a turbulent air flow therein at typically generated frequencies.

In some embodiments, it is desirable for the cross-sectional area of the opening, or second port 216, to be the same as or greater than the cross-sectional area of the internal region of the cabinet 201. However, in some other embodiments, the cross-sectional area at the second port 216 is sized smaller than the cross-sectional area of the internal region 205 of the cabinet 201, but is sized so as not to create a significant impedance to air flow, which will cause distortion, or generate an undesirable air speed at the second port 216 during use. It is believed that ratios of the opening area of the second port 216 to the cross-sectional area of the internal region 205 that are greater than or equal to a ratio of 1:2 will not create a significant impedance to air flow at the exit of the cabinet 201, and thus cause a minimal distortion of the generated sound. In some embodiments, a ratio of the opening area of the second port 216 to the cross-sectional area of the internal region 205 is greater than 1:2, or greater than 1.25:2, or greater than 1.5:2, or greater than 1.75:2, or greater than 1:1.

In some embodiments, a diameter of the internal region 205 of the cabinet 201 is substantially the same or greater than the diameter of the driver 210. In some embodiments, the cross-sectional area of the internal region 205 of the cabinet 201 is substantially the same or greater than the area of the driver 210 (e.g., area of driver is formed by projecting the front face of the driver on a plane that is facing the front of the driver (e.g., a driver with an 8 inch (in) diameter has an area of about 50 in²)). In some other embodiments, the cross-section area of the internal region 205 of the cabinet 201 is at least 80% of the area of the driver 210, such as at least 90% of the area of the driver 210, such as at least 95% of the area of the driver 210, such as at least 98% of the area of the driver 210, or at least 99% of the area of the driver 210. In some embodiments, the cross-sectional area of the internal region 205 of the cabinet 201 at any point along a length of the internal region that extends between a first side of the driver and the second port 216 is at least 80% of the area of the driver 210, such as at least 90% of the area of the driver 210, or at least 95% of the area of the driver 210, or at least 98% of the area of the driver 210, or at least 99% of the area of the driver 210. In some embodiments, the cross-sectional area of the internal region 205 of the cabinet 201 at any point along a length of the internal region that extends between a first side of the driver and the second port 216 and between the second side of the driver and the first port 215 is at least 80% of the area of the driver 210, such as at least 90% of the area of the driver 210, or at least 95% of the area of the driver 210, or at least 98% of the area of the driver 210, or at least 99% of the area of the driver 210.

In one or more embodiments, there may be more than one driver 210 positioned in the cabinet 201. In some embodiments, there are two drivers 210, wherein the first driver is positioned towards the first end 212 of the cabinet 201 and the second driver is positioned towards the second end 213 of the cabinet 201. In some embodiments, the first driver and the second driver are wired so that the sound waves generated by the drivers are substantially 180 degrees out of phase. In some other embodiments, the first driver and the second driver are wired so that they are between 5-10 degrees of being 180 degrees out of phase. In one or more embodiments, there may be more than two drivers 210 positioned within the cabinet 201.

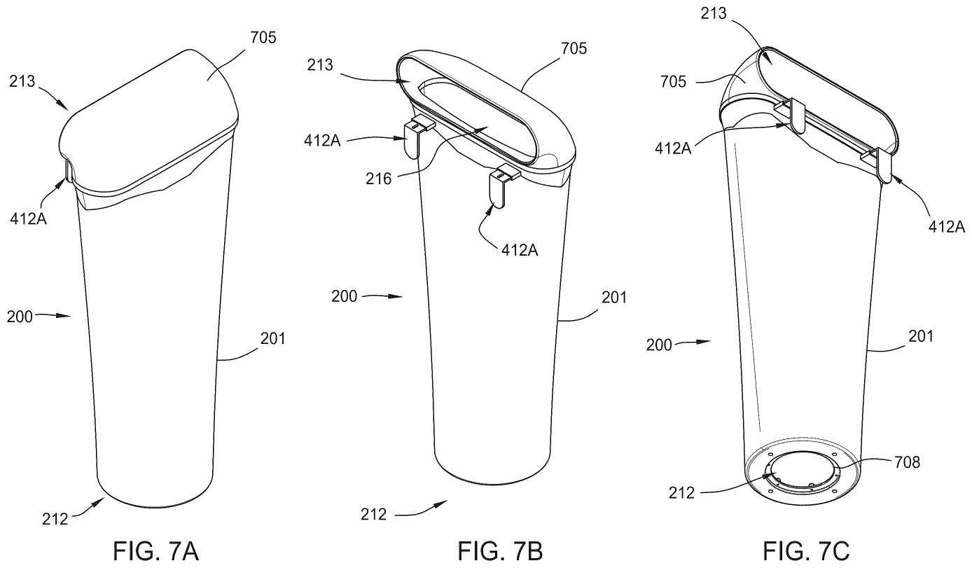

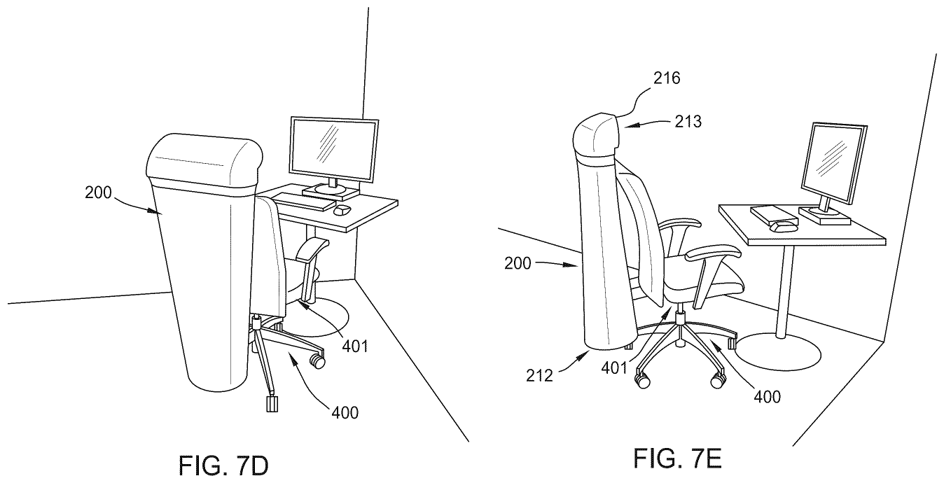

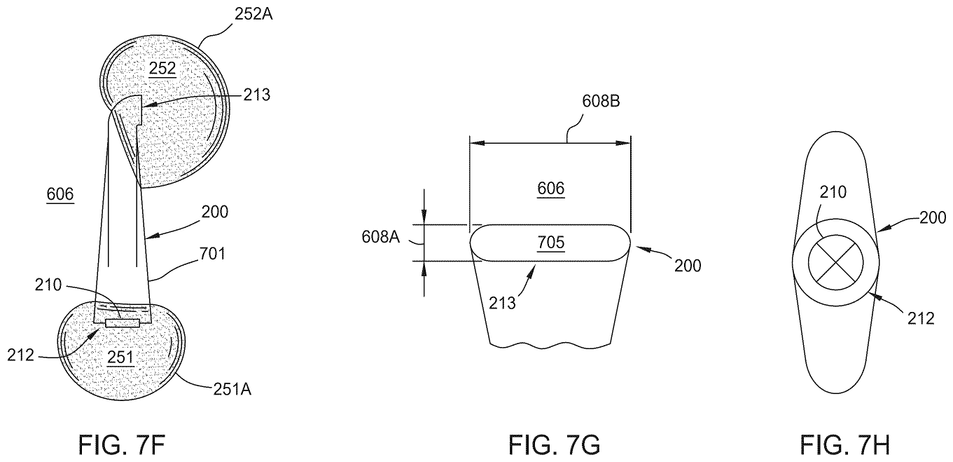

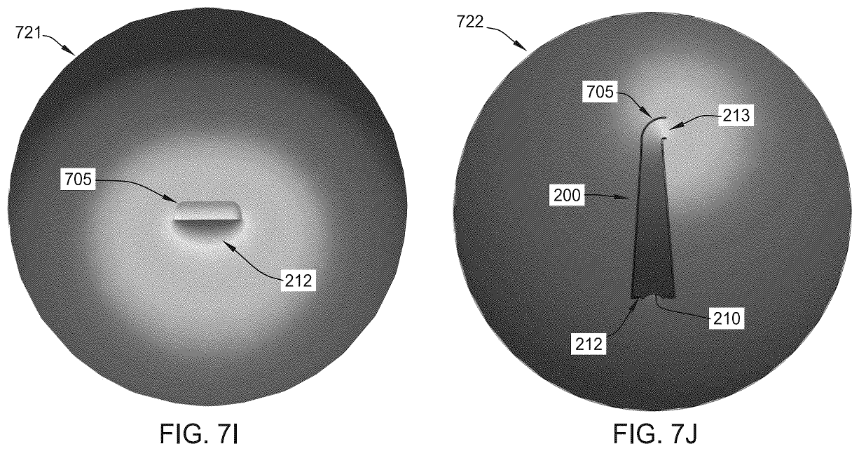

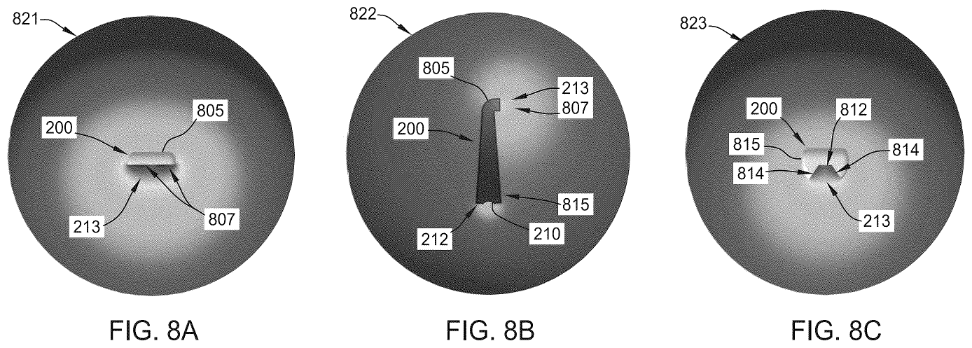

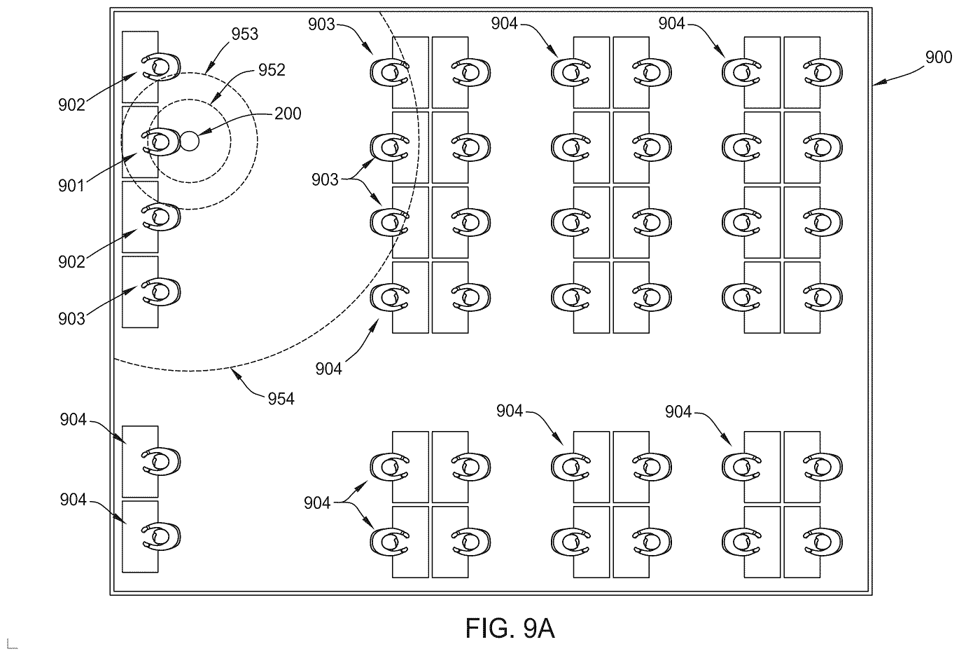

The first port 215 at the first end 212 of the cabinet 201 and the second port 216 at the second end 213 of the cabinet may have different shaped openings. In one or more embodiments, the openings of the first port 215 and the second port 216 have circle-shaped openings. In one or more embodiments, the openings of the first port 215 and the second port 216 have oval-shaped openings. Additionally, in some embodiments, the first port 215 and the second port 216 may be positioned at an angle so the sound waves emit from a plane not parallel to the cabinet 201 as seen in FIGS. 7A-7C. In some embodiments, the first port 215 and the second port 216 have multiple openings. In some embodiments, one of the ports 215, 216 has two openings in which the sound waves emit through the cabinet 201, such as the embodiments seen in FIGS. 8A-8C.

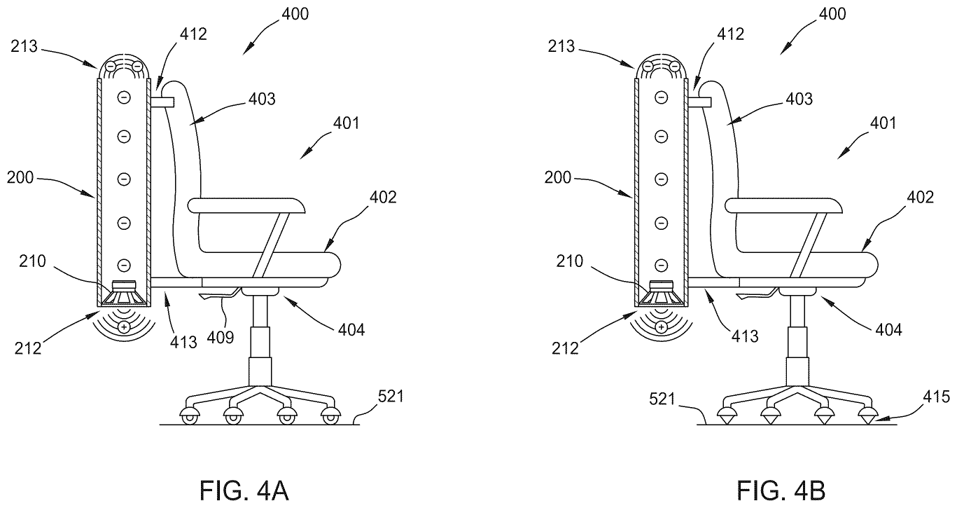

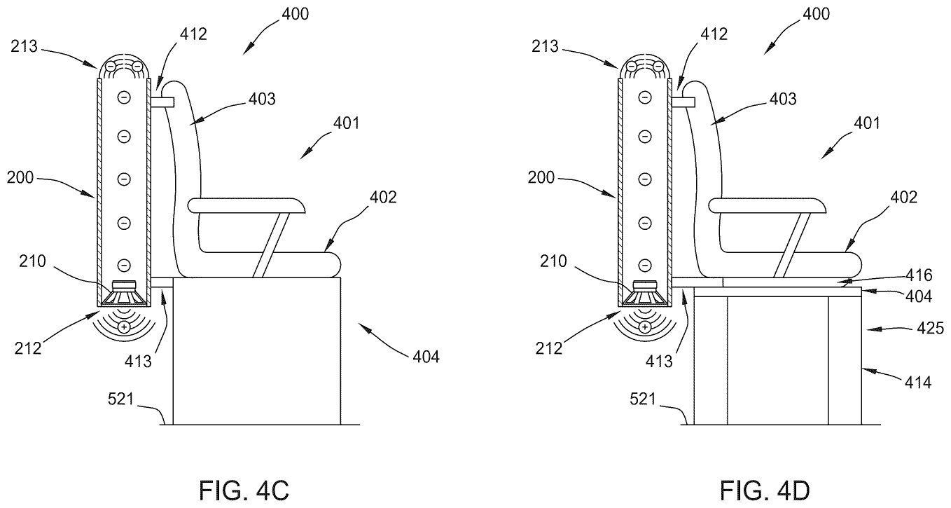

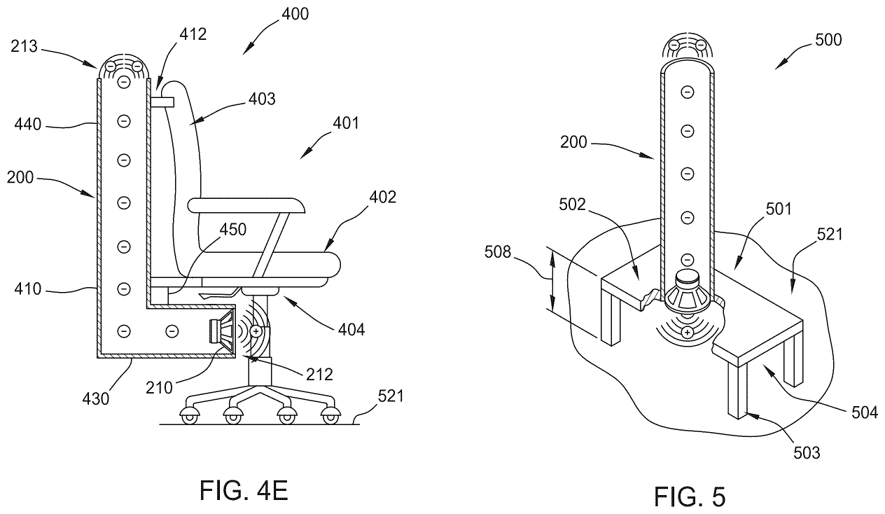

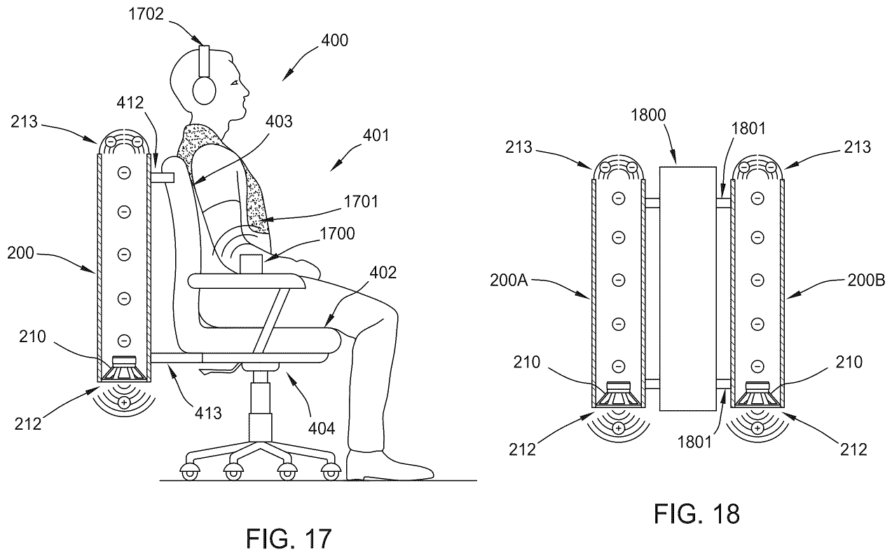

As seen in FIG. 4A, the dipole speaker assembly 200 may be coupled to a supporting structure, such as a chair 401, to form a chair assembly 400. The chair assembly 400 includes a chair 401, a seat 402 coupled to a structural base 404 of the chair 401, a back support 403 coupled to the structural base 404 of the chair 401, and a dipole speaker assembly 200. The dipole speaker assembly 200 may be coupled to any of the components of the chair 401 of the chair assembly 400, such as the seat 402, structural base 404, or a back support 403, via one or more mounting elements, or one or more cabinet attaching elements, 412. The chair 401 is not restricted to a chair and may be any supporting structure that the dipole speaker assembly 200 can attach to while still exposing both the first end 212 and the second end 213 to the listening environment so as to create localized audible regions 251, 252 at the ends of the cabinet 201 that dissipate away from the cabinet 201. Further, the supporting structure can include a supporting element that is configured to support a portion of one or more users. The supporting structure can be configured to cause a position of a head of the user to be at or within a first distance from a sound opening (e.g., second port 216 at the second end 213 (FIG. 17)) when the user is positioned on the supporting element, such as, for example, a lower torso portion of the user being positioned on a seat 402. The first distance can be measured between a center point of the sound opening and an ear of the user. As noted above, the first distance can be between zero millimeters (mm) and 1 meter (m), such as between 1 mm and 0.5 m, or between 1 mm and 0.4 m, or between 1 mm and 0.3 m, or between 1 mm and 0.2 m, or between 1 mm and 0.1 m.

A user may be positioned within the supporting structure so that the user's head is positioned proximate to either the first end 212 or the second end 213. The user's head may be positioned within either the first audible sound region 251 or second audible sound region 252. In some embodiments, the second port 216 has an angled opening. The width of the angled opening is greater than the width of a user's head. Accordingly, in this embodiment, the angled opening of the second port 216 partially surrounds the user's head so as to produce an increased sound pressure level on each side of the user's head as compared to the sound pressure level produced with a non-angled opening of the second port 216 as discussed above. The angled opening of the second port 216 may surround a range of about 2% to about 100% of the user's head. In one embodiment, the second port 216 surrounds 10% of the user's head. In this embodiment, the second port 216 is similar to the port 805 disclosed in FIG. 8A. In one embodiment, the second port 216 surrounds a range of about 20% to about 60% of the user's head. In this embodiment, the second port 216 is similar to the port 815 disclosed in FIG. 8C. In one embodiment, it is contemplated that the second port 216 has an opening such that it surrounds 100% of the circumference of the user's head, from ear to ear. In such an embodiment, the second port 216 would be shaped like a ring to include an opening on the interior surface of the second port 216. Such embodiments may be coupled to a virtual reality device to enhance the immersive experience by generating sound around 100% of the circumference of the user's head, from ear to ear.

It should be appreciated that the angled opening could be positioned on the first port 215 at the first end 212 of the cabinet 201 and the orientation of the cabinet 201 could be flipped so that the first end 212 of the cabinet 201 is positioned above the second end 213 of the cabinet. It should be further appreciated that the orientation of the cabinet 201 could be flipped in this manner in any of the embodiments described herein and is not specific to the particular embodiment described herein regarding the angled opening of either the first port 215 or the second port 216.

In some embodiments described herein, energy is wasted when sound waves are directed out of the first port 215 and directed towards the ground. In an effort to direct and make use of the energy generated by a driver, in some embodiments, the first port 215 and second port 216 may be positioned so that the sound waves delivered from either the first end 212 or the second end 213 are ported towards a desired portion of a user positioned within the chair assembly 400. In some embodiments, the cabinet and/or first port 215 are angled to direct the generated sound waves to the torso, legs, or feet of a user. In these embodiments, the user feels the effects of the sound waves produced from the opening of the first port 215 because the generated sound waves are directed towards the user. In other embodiments, each of the first port 215, second port 216, and/or cabinet may be angled, positioned, or shaped differently to direct, or port, the sound waves generated from either end 212, 213 towards a portion of the user. In other embodiments, each of the first port 215, second port 216, and/or cabinet may be angled, positioned, or shaped differently to direct, or port, the sound waves generated from either end 212, 213 away from the user and/or to other structures and devices. For example, the sound waves emitted from the opening of the first port 215 may be ported to a portion of a gaming device component, such as a steering wheel coupled to the chair 401 of the chair assembly 400.

As discussed above in relation to the dipole speaker assembly 200, the length 209 of a cabinet 201 that is to be coupled to the chair 401 may be adjusted to provide a specific user experience. Additionally, the distance between the first end 212 and the surface that the chair assembly 400 is positioned on (e.g. the floor 521) may be adjusted. The chair assembly 400 may further include a height lever, or seat height actuation device 409. The height lever or seat height actuation device may be activated to increase or decrease the distance between the seat 402 and the floor (e.g. moving the seat 402 up and down). Accordingly, the dipole speaker assembly 200 coupled to the chair 401 may also move up and down as the height of the seat 402 is adjusted. However, the distance between the first end 212 and the floor 521 may affect the propagation of the sound waves throughout the listening environment, especially sound waves in the lower frequency ranges (e.g., less than 100 Hz). As a result, the shape and size of the localized audible regions 251, 252 may vary.

FIG. 4B illustrates a dipole speaker assembly 200 coupled to a chair 401, the chair 401 having feet 415 that decrease in width in the vertical direction to decrease the contact area between the supporting components of the chair 401 and the floor 521 on which it rests. The width of the feet 415 of the chair 401 may decrease in width such that the feet 415 come to a point that contacts the ground at a single point. In some embodiments, the width of the feet 415 decreases in width such that the width at the bottom of the feet 415 is less than the width at the top of the feet 415. In some embodiments, the width at the bottom of the feet 415 is from about 2% to about 80% of the width at the top of the feet 415. Decreasing the width, and thus contact area, of the feet 415 can be used to minimize the transmission of vibrations to the floor 521 that the chair 401 is positioned on.

In one or more embodiments, the feet 415 of the chair 401 may be made of a material that absorbs some or all of the generated vibrations delivered to the feet 415. For example, the feet 415 may be made of a rubber material.

FIG. 4C illustrates a dipole speaker assembly 200 coupled to a chair 401, the chair 401 having a base 404 that extends to the ground to directly couple a portion of the chair to the floor 521. In some embodiments, the base 404 may include a structure that spans an area greater than the lateral area of the seat 402. In some embodiments, the base 404 may include a structure that extends past one or more of the lateral edges of the seat 402 to provide structural rigidity or stability to the chair 401. In other embodiments, the base 404 may have an area smaller than the area of the seat 402. The base 404 may be made of a material that is configured to absorb one or more of the frequencies generated by the dipole speaker assembly 200. For example, the base 404 may be made of an elastomer (e.g., rubber) material.

FIG. 4D illustrates a dipole speaker assembly 200 coupled to a chair 401, the chair 401 having a base 404 with a support structure 425 that can include one or more supports 414 that are positioned between the ground and the seat 402. The support structure 425 also includes the base 404. The supports 414 may be coupled to the base 404 by any suitable means including, but not limited to, mechanical fasteners, tension connections, or snap-fit interfaces. The mechanical fasteners include nuts and bolts, screws, and brackets. The base 404 may include any number of supports 414 that provide structural support for a user positioned in the chair 401.

As shown in FIG. 4D, the chair assembly 400 may include a tunable layer 416. The tunable layer 416 may be disposed above the base 404 and below the seat 402. The tunable layer 416 is configured to modulate and/or control the amount of energy, in the form of vibrational energy, that is transferred to the seat 402, and between the seat 402 and the ground (floor) 521 on which the seat 402 rests. In some configurations, the degree of coupling between the received sound waves generated by the driver 210 and the seat 402 can be controlled by controlling the stiffness of the components within the tunable layer 416. The tunable layer 416 can include components that include vibration-damping materials (e.g., elastomeric material) or vibration-transmission-enabling materials (e.g., metal or plastic), and include a structural shape and/or materials (e.g., anisotropic materials) that are configured to transmit the vibrational energy in one or more directions (e.g., Z-direction) and dampen or limit the transmission in one or more other directions (e.g., X and/or Y-directions).

The amount of vibrational energy transmission will increase as the resonant frequency of a portion of the tunable layer 416 approaches the frequency produced by the dipole speaker assembly 200. The amount of generated or transmitted energy decreases, or dampens, as the resonant frequency of the tunable layer 416 is further from the frequency produced by the dipole speaker assembly 200. Material properties, such as Young's modulus and density, of the tunable layer 416 may be adjusted to control the resonant frequency of the tunable layer 416. The structural elements within the tunable layer 416 may be configured to have a first resonant frequency similar to the frequency of the sound waves delivered by the driver 210 in a first direction and a second resonant frequency in a second direction, wherein the first resonant frequency is different from the second natural resonant frequency. In one or more embodiments, the resonant frequency of the tunable layer 416 is substantially similar to the frequency of the sound waves delivered by the driver 210. In one or more embodiments, the resonant frequency of the tunable layer 416 is within about 2% of the frequency of the sound waves delivered by the driver 210. In one or more embodiments, the resonant frequency of the tunable layer 416 is within from about 1% to about 10% of the frequency of the sound waves delivered by the driver 210.

In one or more embodiments, the natural resonance frequency of the tunable layer 416 is not similar to the frequency of the sound waves delivered by the driver 210. The frequency difference may be desired to produce a dampening effect such that the tunable layer 416 does not produce vibrational effects. In one or more embodiments, the natural resonance frequency of the tunable layer 416 is within from about 30% to about 70% of the frequency of the sound waves delivered by the driver 210.

The tunable layer 416 is positioned below the seat 402 to direct vibrational effects to a user positioned in the chair 401. In one or more embodiments, the tunable layer 416 is disposed behind the seat back 403 to direct vibrational effects to a user's upper torso.

While the tunable layer 416 is only shown in FIG. 4D, it may be included within other chair assemblies 400, such as those shown in FIGS. 4A-4C. In other embodiments, not limited to chair assemblies 400, the tunable layer 416 may be positioned away from the dipole speaker assembly 200 such that the tunable layer 416 is not physically coupled to the dipole speaker assembly 200. In these embodiments, the tunable layer 416 is positioned such that it can receive the sound waves produced by the dipole speaker assembly 200.

FIG. 4E illustrates a dipole speaker assembly 200 coupled to a chair 401, the dipole speaker assembly 200 having a horizontal section 430, according to one or more embodiments of the disclosures. The horizontal section 430 extends from a vertical section 440 of the cabinet 410. The horizontal section 430 is disposed below the seat 402 of the chair 401. The driver 210 is positioned at the first end 212 of the cabinet 410. In one or more embodiments, the driver 210 is positioned below the seat 402 of the chair 401. In these embodiments, the driver 210 is configured to generate haptic vibration effects that are directed to the seat 402 of the chair 401. In some embodiments, the driver 210 and dipole speaker assembly 200 are configured to generate audible sound waves in a desired frequency range, such as between 10 Hz and 400 Hz, between 20 Hz and 200 Hz, or even between 20 Hz and 100 Hz, to cause haptic vibration effects to be directed to the seat 402 and a user disposed thereon.

The horizontal section 430 may be coupled to the vertical section 440 at any suitable angle and have a desired bend radius that couples the two sections. In one or more embodiments, as shown in FIG. 4E, the horizontal section 430 is coupled to the vertical section 440 at an angle 450 of about 90 degrees. In one or more embodiments, the horizontal section 430 is coupled to the vertical section 440 at an angle 450 between about 30 degrees to about 180 degrees. In some embodiments, the bend radius can be between 0.5 inches and 72 inches.

The configuration of FIG. 4E builds upon previously described embodiments by enabling a greater degree of customization in the way sound and vibration are delivered to different regions of the chair assembly 400 by positioning the horizontal section 430 beneath the seat. In particular, the placement of the horizontal section 430 can be coordinated with tunable layers (as in FIG. 4D), which may be disposed above or below the horizontal section 430 to selectively resonate at one or more target frequencies. This enables fine-tuned haptic feedback that can be tailored for individual users or specific listening environments. The design can also accommodate telescoping sections, as discussed in other figures, allowing the cabinet 410 to expand or contract in response to changes in chair height or user preference. By incorporating telescoping or adjustable elements, the system maintains a consistent relationship between the dipole speaker assembly 200, the user, and the environment, thereby enhancing both sound propagation and vibrational feedback.

FIG. 2B illustrates a dipole speaker assembly 200 including telescoping sections 235 in an expanded form. FIG. 2C illustrates a dipole speaker assembly 200 including telescoping sections 235 in a collapsed form. The telescoping sections 235 compensate for the change in distance from the floor 521. In these embodiments, sections of the cabinet 201 collapse into the internal region 205 as the cabinet 201 “shrinks”. The cabinet 201 “shrinks” to decrease the length 209 of the cabinet 201. The cabinet 201 may shrink when the height lever is activated to decrease the distance between the seat 402 and the floor 521. Accordingly, the distance between the first end 212 and the floor 521 will remain substantially the same because the length 209 of the cabinet 201 decreases. As the cabinet 201 “expands”, sections of the cabinet 201 that were collapsed into the internal region 205 expand out to increase the length 209 of the cabinet 201. When the height lever is activated to increase the distance between the seat 402 and the floor 521, the cabinet 201 may “expand”. Similar to when the cabinet “shrinks”, the distance between the first end 212 and the floor 521 will remain substantially the same during the height lever activation because the distance between the first end 212 and the floor 521 is also increasing. Accordingly, the telescoping sections of the cabinet 201 are implemented to compensate for the changes in distances between the seat 402 and the floor 521.

In some embodiments, there may be multiple telescoping sections that nest into one another within the internal region 205 of the cabinet 201. Each telescoping section may contact a notch 240 to indicate the length 209 of the cabinet 201 to a controller. Rather than a continuously variable length of the cabinet 201, the cabinet 201 may be configured such that the cabinet length is configurable to the extents of notched telescoping sections. In some embodiments, the telescoping feature is accomplished by placing an internal shaft (not shown) inside the internal region 205 of the cabinet 201. The internal shaft may be adjusted to collapse into the internal region 205, thus decreasing the overall length 209 of the cabinet 201. Alternatively, the internal shaft can be adjusted to extend outside of the internal region 205, thus increasing the overall length 209 of the cabinet 201. In these embodiments, the length 209 of the cabinet 201 is adjusted along a continuum rather than at discrete positions as disclosed in the aforementioned embodiment.

In embodiments in which the dipole speaker assembly 200 includes one or more telescoping sections 235, the opening of the first end 212 in which the driver 210 is positioned may be larger than the opening of the second end 213. In these embodiments, the first end 212 may include a barrier covering part of the opening of the first end 212 such that the cross-sectional area of the opening of the first end 212 is substantially equivalent to the cross-sectional area of the opening of the second end 213.

Haptic vibration effects can be produced by the sound waves produced in the cabinet 201 of the dipole speaker assembly 200, which may travel through and vibrate the seat 402, structural base 404, back support 403 of the chair 401, and any combination thereof. In one or more embodiments, the dipole speaker assembly 200 may be connected to the chair 401 of the chair assembly 400 without the use of the one or more of the mounting elements 412. In these embodiments, the haptic vibration effects produced by the sound waves produced in the cabinet 201 of the dipole speaker assembly 200 are weakened and may not travel through and vibrate the seat 402 and/or back support 403 of the chair 401. In some embodiments, one of the mounting elements 412 is operably or selectively coupled to the dipole speaker assembly 200. In these embodiments, a lever or other actuating mechanism may be actuated to configure the chair assembly 400 into an activated haptic mode including one or more haptic mounting elements of the chair assembly 400 connected to the dipole speaker assembly 200. The lever or other actuating mechanism may be actuated to configure the chair assembly 400 from the activated haptic mode into a deactivated haptic mode, wherein the one or more haptic mounting elements of the chair assembly 400 is no longer connected to the dipole speaker assembly 200 and the travel of haptic vibration effects from the dipole speaker assembly 200 to the chair assembly 400 is limited.

In some embodiments the dipole speaker assembly 200 is coupled to the chair 401 via a haptic coupling 413. The haptic coupling 413 may be a rigid or semi-rigid coupling. In some embodiments with a rigid haptic coupling 413, the haptic coupling 413 transfers more than 60% of the haptic vibration effects to the user positioned in the chair 401. In one example, the haptic coupling 413 is configured to transmit at least 60% of the magnitude of the vibrations generated by the driver. In some embodiments with a semi-rigid haptic coupling 413, the haptic coupling 413 transfers less than 60% of the haptic vibration effects to the user positioned in the chair 401. In this example, the haptic coupling 413 is configured to transmit less than 60% of the magnitude of the vibrations generated by the driver. The portion of the haptic vibration effects that travel from the driver 210 to the chair assembly 400 increase as the rigidity of the haptic coupling 413 increases. The haptic coupling 413 may be tightened or loosened to adjust the portion of haptic vibration effects traveling to the chair 401.

The haptic coupling 413 may be made of any suitable material and may be of any suitable length. The rigid haptic coupling may be made of any suitable material that physically connects the dipole speaker assembly 200 to the chair 401 while allowing a large portion of the haptic vibration effects to transfer to the chair 401. The semi-rigid haptic coupling 413 may be made of any suitable material that physically connects the dipole speaker assembly 200 to the chair 401 while limiting the amount of haptic vibration effects that transfer to the chair 401. In some embodiments, the haptic coupling 413 is a loose string-like coupling that hangs loose to deliver less haptic vibration effects to the chair 401. However, the haptic coupling 413 may be shortened and tightened to increase the haptic vibration effects delivered to the chair 401.

In one or more embodiments, the dipole speaker assembly 200 is mechanically decoupled, or isolated, from surrounding components such that the haptic vibration effects movement to the surrounding environment is substantially limited. The dipole speaker assembly 200 may be isolated from surrounding components by coupling the dipole speaker assembly 200 to the chair assembly 400 using a vibration isolator. The vibration isolator includes, but is not limited to, a vibration dampening material made of an elastomer (e.g., a rubber) or a structural design that is configured to dampen the transmitted vibrations, such as a foam material or a spring containing structure. The dipole speaker assembly 200 may include a damping mechanism that reduces the amplitude and duration of vibrations, assisting in the isolation of the environment from the haptic vibration effects produced by the dipole speaker assembly 200.

In some embodiments, the haptic vibration effect generated by the driver(s) 210 is manipulated according to the coupling between the dipole speaker assembly 200 and the chair 401. The sound waves generated by the dipole speaker assembly 200 produce the haptic vibration effects in other components physically coupled to the driver 210. The haptic vibration effects may be directed to certain positions of the chair assembly 400 by using more rigid couplings connecting to those certain positions. For example, one or more rigid couplings may be used to more rigidly attach the driver 210 in the cabinet 201 to the back support 403 of the chair 401 to direct more of the haptic vibration effects to the back support 403. In other embodiments, the one or more direct rigid couplings may be used to more rigidly attach the driver 210 in the cabinet 201 to the seat 402 of the chair 401 to direct more of the haptic vibration effects to the seat 402.

While the haptic vibration effects may be primarily affected by the mounting elements 412, haptic coupling 413, and structure of chair assembly 400, on which a user is positioned, the haptic vibration effects in the chair assembly 400 may also be affected by the position of the driver 210 within the cabinet 201 of the dipole speaker assembly 200 attached to the chair 401. If the driver 210 is positioned lower within the cabinet 201, then the haptic vibration effects will typically be more greatly felt in the lower portion of the back support 403 and seat 402. If the driver 210 is positioned higher within the cabinet 201, then the haptic vibration effects will be more greatly felt in the upper portion of the back support 403 and less haptic vibration effects will be felt in the seat 402. Accordingly, the position of the driver 210 within the cabinet 201 affects the amount of haptic vibration effects delivered to different portions of the user positioned in the chair 401.

The haptic vibration effects in the chair assembly 400 may also be affected by the position of the haptic coupling 413 and/or the mounting elements 412. Positioning the haptic coupling 413 and/or the mounting elements 412 closer to the desired portion of the user increases the intensity of the haptic vibration effects delivered to that portion of the user. The intensity is increased because the vibrations travel a shorter distance to reach the user and thus do not lose as much energy and intensity as traveling to the desired portion of the user.

A method of producing haptic vibration effects in a chair assembly 400 is disclosed below. The features discussed before and after may be incorporated into this method. The method includes receiving a signal from an input device. The input device may be any device that has the capability to send sound data in the form of signals that can be interpreted and used by the dipole speaker assembly 200. The signal sent to the dipole speaker assembly 200 may be one of two types. The first type of signal will result in the generation of increasing vibrational amplitudes within components of the chair 401 due to the delivery or generation of haptic vibration effects at one or more resonance frequencies of one or more components within the chair 401 (e.g., tunable layer 416) by the driver 210. When the first signal is sent, more haptic vibration effects will be directed towards the user positioned in the chair assembly 400. The second type of signal will result in a decreasing vibrational amplitude within components of the chair 401 due to the delivery or generation of haptic vibration effects at frequencies that are a distance from the resonance frequencies of the components within the chair 401 (e.g., tunable layer 416) by the driver 210. When the second signal is sent, less haptic vibration effects will be directed towards the user positioned in the chair assembly 400. In some embodiments, the signal may be non-binary. Instead of only two signals being generated to alter the generated vibrational amplitude within components of the chair 401, the generated signal can be adjusted to alter the generated vibrational amplitude within components of the chair 401 to a certain degree. A non-binary signal allows for the amount of haptic vibration effects delivered to a user to vary along a continuum rather than only in two discrete amounts based on the binary signal sent. The method of producing haptic vibration effects in a chair assembly 400 further comprises activating the driver 210 of the dipole speaker assembly 200 to produce sound waves once the signal is received from the input device.

It should be appreciated that all of the features and embodiments disclosed in relation to a chair 401 may also be incorporated into other supporting structures coupled to the dipole speaker assembly 200. For example, a supporting structure may not include a seat 402 exactly like a chair 401, but the supporting structure could still be coupled to a dipole speaker assembly 200 including a cabinet 201 that is positioned below a surface of the supporting structure.

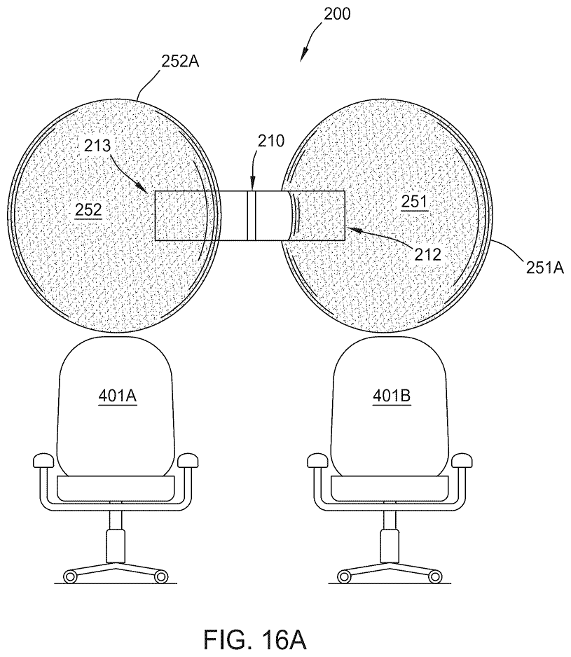

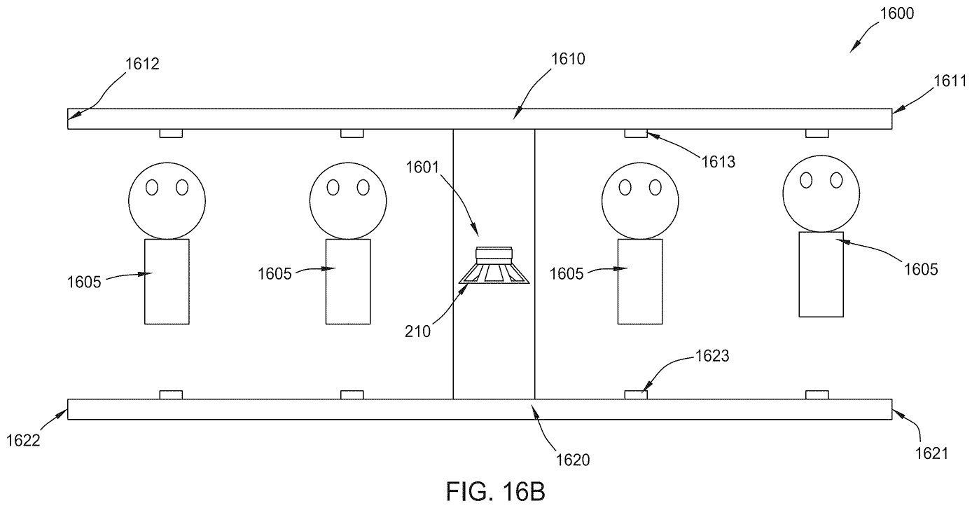

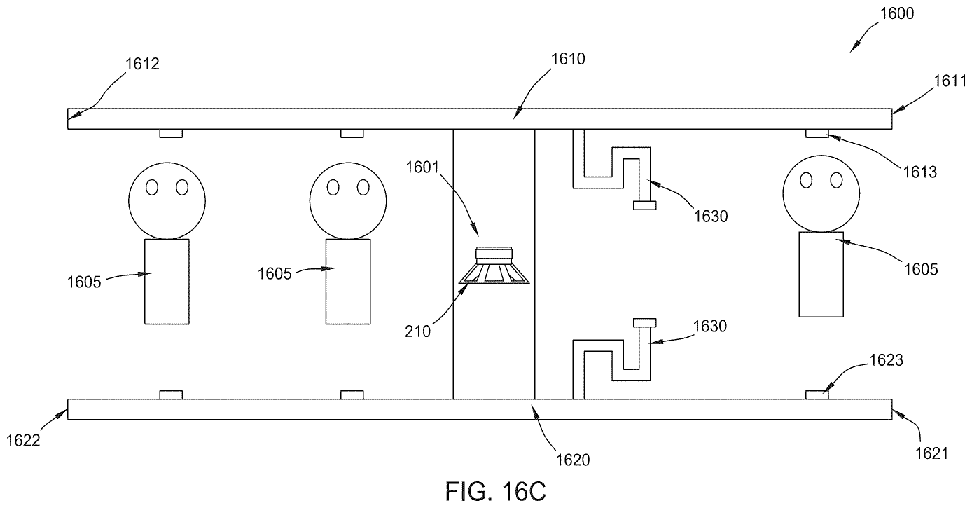

As seen in FIG. 16A, the dipole speaker assembly 200 may be positioned such that the first end 212 is positioned near the head of a first user and the second end 213 is positioned near the head of a second user. In one embodiment, as shown in FIG. 16A, the dipole speaker assembly 200 is positioned so that the first user is sitting next to the second user while facing the same direction and within the same horizontal plane. However, it is contemplated that the dipole speaker assembly 200 could be positioned so that the first user is sitting behind the second user and within the same horizontal plane. In these embodiments, the first user may be facing the same direction as the second user. Alternatively, the first user may be facing in the opposite direction from the second user. In some embodiments, the cabinet 201 of the dipole speaker assembly 200 is oriented so that the first end 212 is lower than the second end 213. In one such embodiment, the head of the first user is positioned near the first end 212, the head of the second user is positioned near the second end 213, and the first user is positioned above the second user. In each of the above recited embodiments, the terms “near the first end 212” and “near the second end 213” can mean “within the bounds of the first audible sound region 251” or “within the bounds of the second audible sound region 252”, respectively.

As seen in FIG. 5, the dipole speaker assembly 200 may also be coupled to a multi-legged base stand (or “stand”) 501 to form a stand assembly 500, wherein the dipole stand assembly 500 is configured to produce either positive sound waves 102 or negative sound waves 104 within a fully enclosed or partially enclosed region within the stand assembly 500. The multi-legged base stand includes a cabinet support plate 502 and at least one cabinet support 503 coupled to the cabinet support plate 502. The stand 501 may be positioned on a floor 521 or wall of an environment in which the cabinet 201 of the dipole speaker assembly 200 is disposed. In these embodiments, one end of the dipole speaker assembly 200 is positioned within an opening of the multi-legged base stand 501. The multi-legged base stand 501 includes a base 504 defined by a distance 508 from the floor 521. Sound waves emitting from the end of the dipole speaker assembly 200 positioned towards the floor 521 are largely restricted within the bounds of the enclosure of the multi-legged base stand 501. In these embodiments, there is minimal cancellation between the positive sound waves 102 and negative sound waves 104 in the listening environment. In this configuration, the dipole speaker assembly 200 will be configured to perform like a conventional speaker assembly design. However, in some embodiments, the multi-legged base stand 501 does not enclose an area at the adjacent end of the dipole speaker assembly 200 and includes openings or open areas that are at least as large as the inner dimension 208 of the internal region 205 of the dipole speaker assembly 200. For example, the multi-legged base stand 501 may only include a mounting plate for the dipole speaker assembly 200 to mount to and at least three supporting legs to support the mounting plate and dipole speaker assembly 200 a distance 508 from the floor 521.

In one embodiment, the second end 213 of the dipole speaker assembly 200 is disposed in the stand 501. The stand 501 includes a cabinet support plate 502 to support the dipole speaker assembly 200 a distance 508 from the floor 521 (e.g., ground). In this embodiment, the base 504 is enclosed so that the negative sound pressure waves 104 traveling through the second end 213 of the dipole speaker assembly 200 do not interfere with the positive sound pressure waves 102 traveling through the first end 212 of the dipole speaker assembly 200 into the listening environment. In this configuration, the dipole speaker assembly 200 will be configured to perform like a conventional speaker assembly design.

In one embodiment, the dipole speaker assembly 200 may switch between two different operating positions. In the first operating position, the cabinet 201 of the dipole speaker assembly 200 is coupled to a supporting structure, such as a chair 401, to form a chair assembly 400. The cabinet 201 of the dipole speaker assembly 200 may be coupled to the supporting structure via a support structure attaching component disposed on the dipole speaker assembly 200. The support structure attaching component may be positioned on an outer surface of the cabinet 201 or an interior surface of the cabinet 201. Additionally, the support structure attaching component may be positioned anywhere on the cabinet 201. In one embodiment, the support structure attaching component is positioned near the second end 213 of the cabinet 201 on the outer surface of the cabinet 201. The support structure attaching component may be rigid or semi-rigid as discussed above. Additionally, the dipole speaker assembly 200 may include more than one support structure attaching components. In other embodiments, the dipole speaker assembly 200 includes a support structure attaching component as well as other couplings to couple the dipole speaker assembly 200 to the supporting structure. In the second operating position, one of the ends 212, 213 of the cabinet 201 is disposed within a stand 501 to form a stand assembly 500. As discussed above, the stand 501 may be completely enclosed or it may include a port or opening for sound waves produced by the end of the dipole speaker assembly positioned in the stand 501 to travel through.

FIG. 17 illustrates a dipole speaker assembly coupled to an auxiliary speaker assembly 1700. In some embodiments, the dipole speaker assembly 200 may be coupled with devices producing sounds within a frequency range other than the sounds within the lower bass sound frequency range produced by the dipole speaker assembly 200. In some embodiments, the dipole speaker assembly 200 is coupled to one or more auxiliary speaker assemblies 1700. The auxiliary speaker assembly 1700 includes an auxiliary driver that produces sounds within a midrange frequency range, such as between 300 Hz and 5,000 Hz. In some embodiments, the dipole speaker assembly 200 is coupled with an auxiliary speaker including a driver that produces sounds within a high frequency range, such as between 2,000 Hz and 20,000 Hz. In some embodiments, the dipole speaker assembly 200 is coupled with a plurality of auxiliary speakers. Each auxiliary speaker includes an auxiliary speaker driver that produces sounds at frequencies outside of the frequency range produced by the dipole speaker assembly 200.

In one or more embodiments, the auxiliary speaker assembly 1700 may be positioned on a chair assembly 400, as shown in FIG. 17. The auxiliary speaker assembly 1700 may be positioned on any component of the chair assembly 400. The auxiliary speaker assembly 1700 is positioned on the chair assembly such that the auxiliary speaker assembly 1700 directs sound waves towards a user positioned within the chair assembly 400. In some embodiments, the auxiliary speaker assembly 1700 is positioned such that sound waves are directed towards an audible region, such as the first audible region 251 or the second audible region 252.

In one or more embodiments, the auxiliary speaker assembly 1700 is positioned away from the dipole speaker assembly 200. In these embodiments, the auxiliary speaker assembly 1700 is positioned such that sound waves produced from the auxiliary speaker assembly 1700 are directed towards the dipole speaker assembly 200.

The auxiliary speaker assembly 1700 may include a headset 1702 or a vest 1701 worn by a user. The headset 1702 may include a high-pass filter to prevent a certain range of low frequency sound waves from being delivered to the user. For example, the headset 1702 may include a high-pass filter that filters out the same range of frequencies as those produced by the dipole speaker assembly 200.

In some embodiments, the devices that the dipole speaker assembly 200 is coupled to are also coupled to the supporting structure, or chair 401, of the chair assembly. For example, in some embodiments, a device in the arm rest of the chair may produce sounds outside of the range of sounds produced by the dipole speaker assembly 200. In some embodiments, a user may wear a vest 1701 that produces sounds outside of the range of sounds produced by the dipole speaker assembly 200. In some embodiments, the chair assembly 400 may be positioned within a pod or larger structure. The pod or larger structure may include auxiliary speakers that produce the sounds outside of the range of sounds produced by the dipole speaker assembly 200.

Each of the devices, including the dipole speaker assembly 200, may be coupled to a controller. The controller sends a plurality of signals to each device. The signals provided by the controller allow a user to better hear the full range of sounds of the intended sound. For example, the devices supplement the higher frequency sounds that the dipole speaker assembly 200 is not configured or required to generate. Accordingly, in some embodiments, the controller is configured to simultaneously send signals to each device so that each device can separately generate audible sounds within non-completely overlapping frequency ranges while ensuring that each device plays the generated sounds in unison. However, in some embodiments, the controller can be configured to simultaneously send signals to two or more of the devices (e.g., vest 1701 and auxiliary speaker assembly 1700) so that each of the two or more devices can generate audible sound within overlapping frequency ranges in unison.

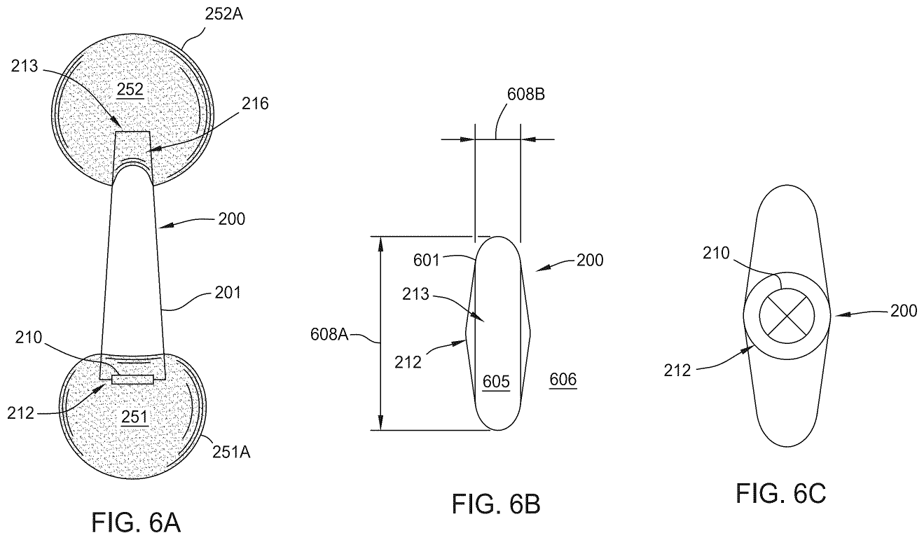

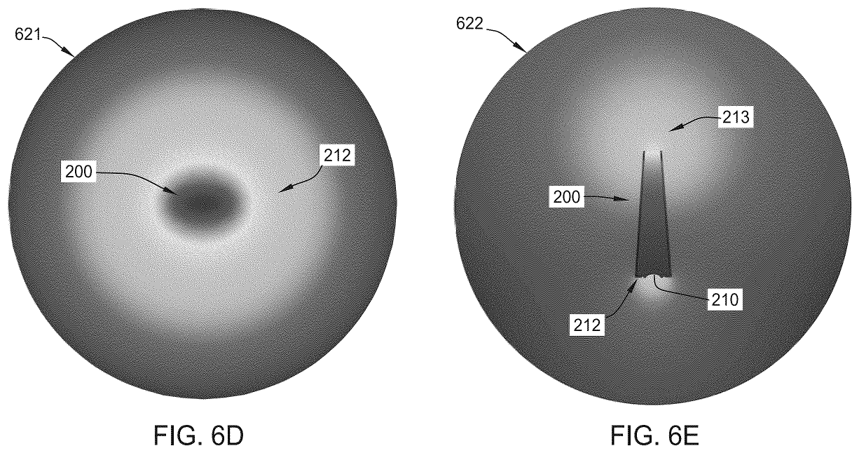

FIG. 6A illustrates the constant sound pressure level regions 251A, 252A of audible sound produced from a dipole speaker assembly with a driver 210 positioned at the first end 212 of the cabinet 601. In this embodiment, the driver 210 (see FIGS. 6A and 6C) is facing towards the bottom of the cabinet 601, so that the positive sound waves 102 travel down and create a first constant sound pressure level region 251A near the first end 212 of the cabinet 201. At the opposing end of the cabinet 601, or second end 213, the dipole speaker assembly 200 includes a second port 216 that has a non-circular shaped (e.g., oval or slot shaped shown in FIG. 6B) opening that includes a second constant sound pressure level region 252A. The non-circular shaped opening has a length 608A and a width 608B that defines an internal region 605. Sound waves travel through the internal region 605 through the dipole speaker assembly 200 to the external region 606. FIGS. 6D and 6E illustrate the simulated free-field sound pressure levels of an environment surrounding the dipole speaker assembly 200 illustrated in FIGS. 6A-6C. FIG. 6D illustrates a simulated free-field sound pressure level map 621 from a top-down perspective of the dipole speaker assembly 200 including a second port 216 with a second cross sectional area, according to one or more embodiments of the disclosure. FIG. 6E illustrates a simulated free-field sound pressure level map 622 from a side perspective of a dipole speaker assembly 200 including a second port 216 with a second cross sectional area and a first port 215 with a first cross sectional area, according to one or more embodiments of the disclosure.

FIGS. 7A-7E illustrate perspective views of a dipole speaker assembly 200 including an angled top port 705, according to one or more embodiments of the disclosure. In this configuration, the driver 210 is facing towards the bottom of the cabinet 201 so that the positive sound waves 102 travel down and create a first constant sound pressure level region 251A near the first end 212 of the cabinet 701, as shown in FIG. 7F. At the opposing end of the cabinet 201, or second end 213 the dipole speaker assembly 200 includes a top port 705. The top port 705 includes a non-circular shaped (e.g., oval or slot shaped shown in FIG. 7G) opening that directs sound waves to create a second constant sound pressure level region 252A near the second end 213 of the cabinet 701. The dipole speaker assembly 200 further includes a bottom port 708 positioned near the first end 212 of the cabinet 701.

FIGS. 7D-7E illustrate perspective views of the dipole speaker assembly 200 including the angled top port 705 that is positioned to provide audible sound to a user positioned in a chair assembly 400. The dipole speaker assembly 200 is mounted to the chair assembly 400 by use of the mounting elements 412A, according to one or more embodiments of the disclosure. The mounting elements 412A can be positioned over a portion (e.g., back support 403) of the chair 401, and thus, in some cases, are not directly connected to the chair 401. In some of the aforementioned embodiments, the haptic vibration effects are separately or additionally configured to travel to the user positioned in the chair assembly 400.

FIGS. 7I and 7J illustrate the simulated free-field sound pressure level maps of an environment surrounding the dipole speaker assembly 200 illustrated in FIGS. 7A-7H. FIG. 7I illustrates a simulated free-field sound pressure level map 721 from a top-down perspective of the dipole speaker assembly 200 including an angled top port 705, according to one or more embodiments of the disclosure. FIG. 7J illustrates a simulated free-field sound pressure level map 722 from a side perspective of a dipole speaker assembly 200 including an angled top port 705 with a first cross sectional area and a bottom port with a second cross sectional area, according to one or more embodiments of the disclosure.

FIGS. 8A and 8B illustrate the simulated free-field sound pressure level maps of an environment surrounding the dipole speaker assembly 200 that includes a side facing top port 805 that includes two openings 807 that are spaced apart in a horizontal plane (FIG. 8A). FIG. 8A illustrates a simulated free-field sound pressure level map 821 from a top-down perspective of the dipole speaker assembly 200 including a side facing top port 805 that has two openings 807. FIG. 8B illustrates a simulated free-field sound pressure level map 822 from a side perspective of a dipole speaker assembly 200 including a top port 805 that has two openings 807 and a bottom port 815, according to one or more embodiments of the disclosure.

FIG. 8C illustrates a simulated free-field sound pressure level map 823 from a top-down perspective of an alternate version of the multiple output port type of the dipole speaker assembly 200 including a side facing top port 815 that has at least two openings 814. In some embodiments, the dipole speaker assembly 200 includes a side facing top port 815 that has at least two openings 814 and a central opening 812 that are configured to provide sound to a user positioned to receive sound provided through the multiple output ports positioned at the second end 213 of the dipole speaker assembly 200.

FIG. 16A illustrates a side view of a dipole speaker assembly that is positioned to provide audible sound to two locations that are configured to support two users during the delivery of sound by a driver, according to one or more embodiments of the disclosure. As illustrated in FIG. 16A, the dipole speaker assembly 200 is positioned so that the first audible region 251 and the second audible region 252 provided at the opposing ends 212, 213 of the dipole speaker assembly 200 are positioned so that users each positioned in a chair 401A, 401B can each hear a portion of the audible sound generated by the driver 210. In some configurations, the chairs 401A and 401B can be replaced by a couch, bench, or other structure that is configured to allow a user positioned at each opposing end of the dipole speaker assembly 200 to receive the sound generated by the driver 210. In one example, as shown in FIG. 16A, the driver 210 may be positioned in a central location within cabinet 201, due to the near symmetric generated sound pressure levels provided at the first end 212 and opposing second 213 of the dipole speaker assembly 200. However, other non-central driver positions within the cabinet 201 may also be used without deviating from the basic scope of the disclosure provided herein.

FIG. 16B illustrates a front view of a dipole speaker assembly 1600 that is positioned to simultaneously provide audible sound to two or more locations. The dipole speaker assembly 1600 includes a central cabinet 1601. A driver 210 is disposed within the central cabinet 1601. The central cabinet 1601 may include components and specifications as those discussed above when referring to the cabinet 201. The dipole speaker assembly 1600 further includes an upper extension port 1610 and a lower extension port 1620. The upper extension port 1610 is coupled to an upper portion of the dipole speaker assembly 1600. The lower extension port 1620 is coupled to a lower portion of the dipole speaker assembly 1600.

The upper extension port 1610 includes a first end 1611 and a second end 1612. The first end 1611 is positioned on the opposite end of the upper extension port 1610 as the second end 1612. The upper extension port 1610 includes at least one upper opening 1613 disposed between the first end 1611 and the second end 1612. The lower extension port 1620 includes a first end 1621 and a second end 1622. The first end 1621 is positioned on the opposite end of the lower extension port 1620 as the second end 1622. The lower extension port 1620 includes at least one lower opening 1623 disposed between the first end 1621 and the second end 1622.

Each of the upper openings 1613 in the upper extension port 1610 are paired with a lower opening 1623 in the lower extension port 1620. The pair of openings 1613, 1623 creates distinct audible regions disposed between each pair of openings 1613, 1623. FIG. 16B illustrates a plurality of users 1605 positioned between each pair of openings 1613, 1623.

In some embodiments, the dipole speaker assembly 1600 may include any number of opening pairs, which include the opening 1613 and opening 1623. The sound pressure level (SPL) provided from the opening pairs closest to the central cabinet 1601 may be greater than the sound pressure level provided from the opening pairs further away from the central cabinet 1601. As shown in FIG. 16C, additional channels 1630 may be added to the openings 1613, 1623 within the opening pairs positioned near the central cabinet 1601 such that the length of the flow path from the driver 210 to each of the openings 1613, 1623 within all of the opening pairs is the same. Accordingly, the sound pressure level of each opening pair may be substantially similar. The additional channels 1630 may include any suitable geometry that results in a flow path equivalent to the distance sound travels from the driver 210 to the pair of openings 1613, 1623 furthest from the central cabinet 1601. The additional channels 1630 may be positioned on one side of the central cabinet 1601 or on both sides of the central cabinet 1601. The additional channels 1630 may have a suitable geometry such that each upper opening 1613 is substantially planar to one another. The additional channels 1630 may have a suitable geometry such that each lower opening 1623 is substantially planar to one another. The user 1605 is removed from in front of the dipole speaker assembly 1600 in FIG. 16C to illustrate the additional channels 1630.

In some embodiments, the combined cross-sectional area of the internal region of each branch of the upper extension port 1610 (e.g., a first branch extends to the left and a second branch extends to the right from the central cabinet 1601 in FIGS. 16B-16C) and the combined cross-sectional area of the internal region of each branch of the lower extension port 1620 (e.g., a first branch extends to the left and a second branch extends to the right from the central cabinet 1601 in FIGS. 16B-16C) at any point along a length of the internal region formed therein is sized as to be at least 80% of the area of the driver 210, such as at least 90% of the area of the driver 210, or at least 95% of the area of the driver 210, or at least 98% of the area of the driver 210, or at least 99% of the area of the driver 210. In one example, the combined cross-sectional area of the internal region of the first branch and the second branch in the upper extension port 1610 is at least 80% of the area of the driver 210. In some embodiments, the combined cross-sectional area of all of the openings 1613 and the combined cross-sectional area of all of the openings 1623 are both sized as to be at least 80% of the area of the driver 210, such as at least 90% of the area of the driver 210, or at least 95% of the area of the driver 210, or at least 98% of the area of the driver 210, or at least 99% of the area of the driver 210. In some embodiments, the combined cross-sectional area of the openings 1613 and the additional channels 1630 and/or the combined cross-sectional area of the openings 1623 and the additional channels 1630 at any point along a length of the internal region formed therein is sized as to be at least 80% of the area of the driver 210, such as at least 90% of the area of the driver 210, or at least 95% of the area of the driver 210, or at least 98% of the area of the driver 210, or at least 99% of the area of the driver 210.

FIG. 18 illustrates a first dipole speaker assembly 200A and a second dipole speaker assembly 200B coupled to a mounting device 1800, according to one or more embodiments disclosed herein. The first dipole speaker assembly 200A is coupled to the mounting device 1800 by one or more mounting elements 1801. The second dipole speaker assembly 200B is coupled to the mounting device 1800 by one or more mounting elements 1801. Haptic vibration effects may travel through the mounting elements 1801 to deliver haptic vibration effects to the mounting device 1800. The material of the mounting elements 1801 and/or the length of the mounting elements 1801 may alter the intensity of the haptic vibration effects to the mounting device 1800. In some embodiments, the mounting device 1800 is coupled to a plurality of dipole speaker assemblies, such as a first dipole speaker assembly 200A positioned on a first side of a user and a second dipole speaker assembly 200B positioned on a second side of the user.

The mounting device 1800 may include a device or component such that a user may wear the mounting device 1800. For example, the mounting device 1800 may include a plurality of straps such that a user can wear the mounting device as a backpack. In these embodiments, two audible regions are produced near the head of the user wearing the mounting device 1800.

In some embodiments, a plurality of dipole speaker assemblies can be coupled to a speaker assembly supporting structure, such as a chair assembly 400 or a dipole stand assembly 500. In some embodiments, at least two of the plurality of dipole speaker assemblies can be configured to generate sound waves within the same frequency range. In one example, the mounting device 1800 is configured to be attached to chair assembly 400, such as the chair assembly 400 illustrated in FIG. 17, and a first dipole speaker assembly 200A positioned on a first side of a user and a second dipole speaker assembly 200B positioned on a second side of the user, and the sound waves generated by the first dipole speaker assembly 200A and the second dipole speaker assembly 200B can be in a frequency range between 10 Hz-200 Hz, such as between 20 Hz-100 Hz. In some embodiments, the drivers 210 in each of the plurality of dipole speaker assemblies are the same size (e.g., 8 inch driver). In one configuration example, a first dipole speaker assembly 200A is mounted on the left side of a chair assembly 400 such that a first sound opening of the first dipole speaker assembly 200A is positioned near to a left ear of a user, while a second dipole speaker assembly 200B is mounted to on the right side of the chair assembly 400 such that a first sound opening of the second dipole speaker assembly 200B is positioned near to a right ear of the user. In this configuration, the two audio drivers in the dipole speaker assemblies create two sources of sound waves, which can be translated into two sources of haptic vibrations. In one case, if both drivers 210 receive the exact same audio signal, it is believed that the combination of the two dipole speaker assemblies will behave like a single speaker assembly with a spatially distributed output. However, in some cases it may be desirable, to provide different audio signals to each dipole speaker assembly, which are both within the same frequency range (e.g., 10 Hz-200 Hz range), which would provide both haptic vibrations and audible sound coming from two different areas (e.g., L and R) to effectively create a multi-zone haptic and/or audible sound experience.

In some embodiments, at least two of the plurality of dipole speaker assemblies can be configured to generate sound waves within two distinctly different frequency ranges or two at least partially overlapping frequency ranges. In one example, the mounting device 1800 is configured to be attached to chair assembly 400, such as the chair assembly 400 illustrated in FIG. 17, and a first dipole speaker assembly 200A positioned on a first side of a user is configured to generate sound waves in a first frequency range (e.g., 20 Hz-100 Hz) and a second dipole speaker assembly 200B positioned on a second side of the user is configured to generate sound waves in a second frequency range (e.g., 100 Hz-500 Hz). In some embodiments, the drivers 210 in each of the plurality of dipole speaker assemblies are differently configured, such as a first driver 210 in a first dipole speaker assembly 200A is an 8 inch driver and a second driver 210 in a second dipole speaker assembly 200B is a 10 inch driver.

In some embodiments, the dipole speaker assembly 200 is formed in a non-straight or non-linear shape (not shown). In one example, the cabinet 201 is formed in a U-shape or a V-shape. In one configuration, the cabinet 201 has a length that is longer than the distance between the first end 212 and the second 213. The length of the cabinet 201 can be defined by a length of a central axis of the internal region 205 that extends from the first end 212 to the second end 213.

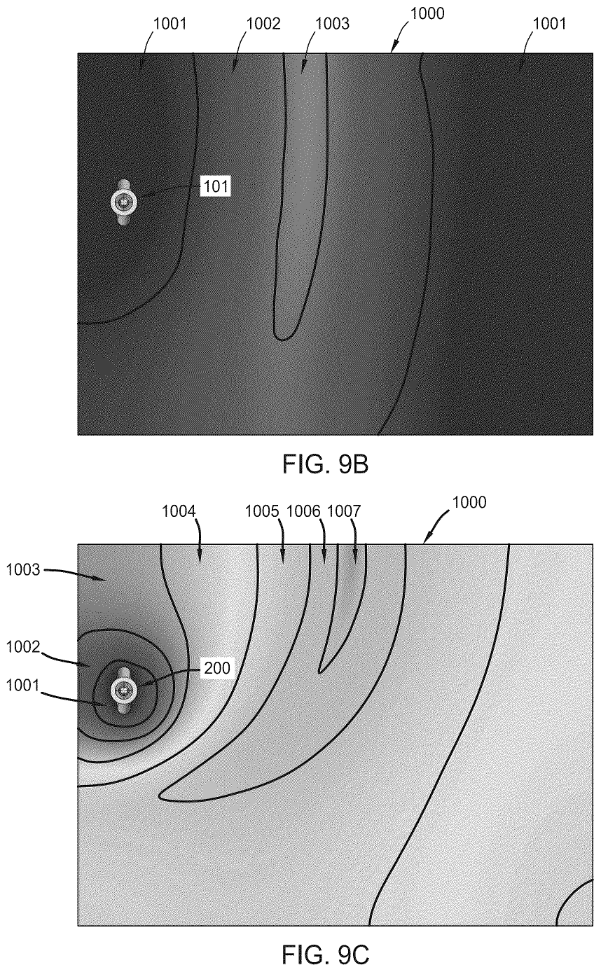

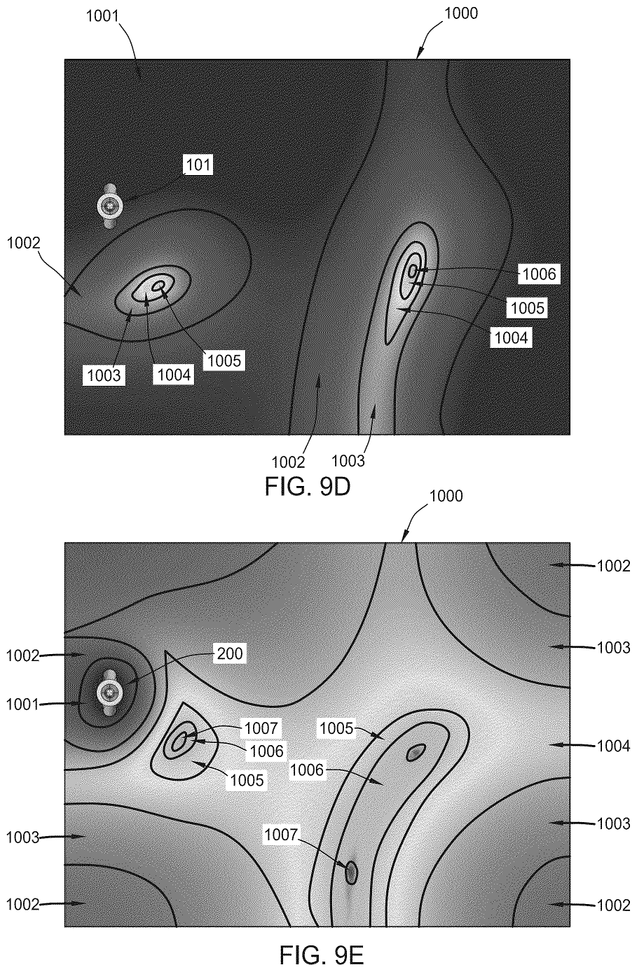

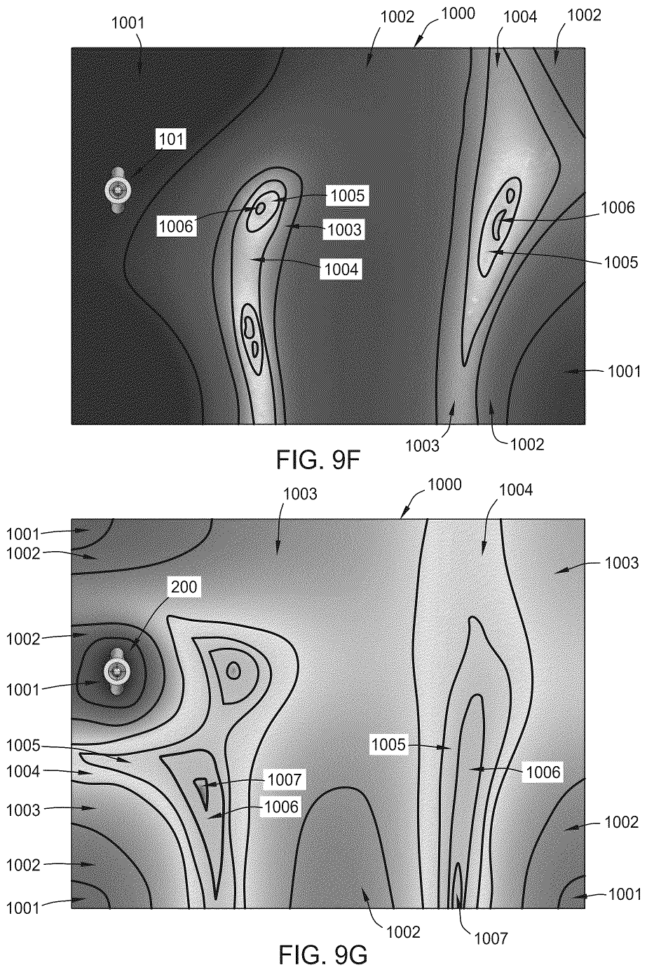

FIG. 9A illustrates a dipole speaker assembly 200 positioned in a listening environment 900. The dipole speaker assembly 200 is coupled to the back support 403 of the chair 401 of an intended listener 901. The most intense sound waves are centralized within an inner audible region 952. The sound waves are less intense at positions further from the dipole speaker assembly 200. Some of these sound waves may still be heard by the first neighbors 902 of the intended listener 901 in an outer audible region 953. Second neighbors 903 located in a distant audible region 954, located further from the intended listener 901, may not hear the sound produced by the dipole speaker assembly 200 as much as first neighbors 902. Additionally, listeners 904 further from the dipole speaker assembly 200 than the second neighbors 903 are unlikely to hear any significant amount of the generated audible sound produced from the dipole speaker assembly 200.

The dipole speaker assembly 200 generates an audible sound into the listening environment 900. The dipole speaker assembly includes a first sound generating source and a second sound generating source. The first sound generating source generates a first portion of the audible sound to the listening environment. The second sound generating source generates a second portion of the audible sound to the listening environment. In one or more embodiments, the first portion of the audible sound corresponds to positive sound waves and the second portion of the audible sound corresponds to negative sound waves. In one or more embodiments, the first sound generating source is a first driver 210 positioned in a first cabinet 201 and the second sound generating source is a second driver 210 positioned in a second cabinet 201, as shown in FIG. 18.

FIGS. 9B, 9D, and 9F illustrate the simulated sound pressure level field maps within a semi-reverberant enclosed environment 900 including a speaker assembly that was configured like a conventional sealed speaker assembly design operating at various frequencies. As a comparison, FIGS. 9C, 9E, and 9G illustrate the simulated sound pressure level field maps within a semi-reverberant enclosed environment 900 including a dipole speaker assembly 200 operating at various frequencies. Sound pressure is localized near the dipole speaker assembly 200 and dissipates further from the dipole speaker assembly 200, specifically in FIG. 9C at the lower base frequency of 30 Hz. Conversely, sound pressure is relatively consistent throughout the listening environment 900 of a conventional sealed speaker assembly (FIG. 9B). A conventional sealed speaker assembly has similar sound pressure outputs throughout the listening environment 900, as illustrated by the small variation in color observed in FIGS. 9B, 9D, and 9F. Alternatively, a sound pressure output generated by a dipole speaker assembly 200 throughout the listening environment 900 significantly changes as the frequency is decreased (e.g., decreased from 80 Hz to 30 Hz), as illustrated by the large variation in color across the listening environment 900 shown in FIGS. 9C, 9E, and 9G. In addition to variations in color, boundaries of regions 1001, 1002, 1003, 1004, 1005, 1006, 1007 are approximated to emphasize the distinctions in sound pressure regions. Region 1001 corresponds to the region with the greatest amount of the generated SPL and region 1007 corresponds to the region with the least amount of the generated SPL. As the region number increases, the relative amount of the generated SPL in that region decreases.

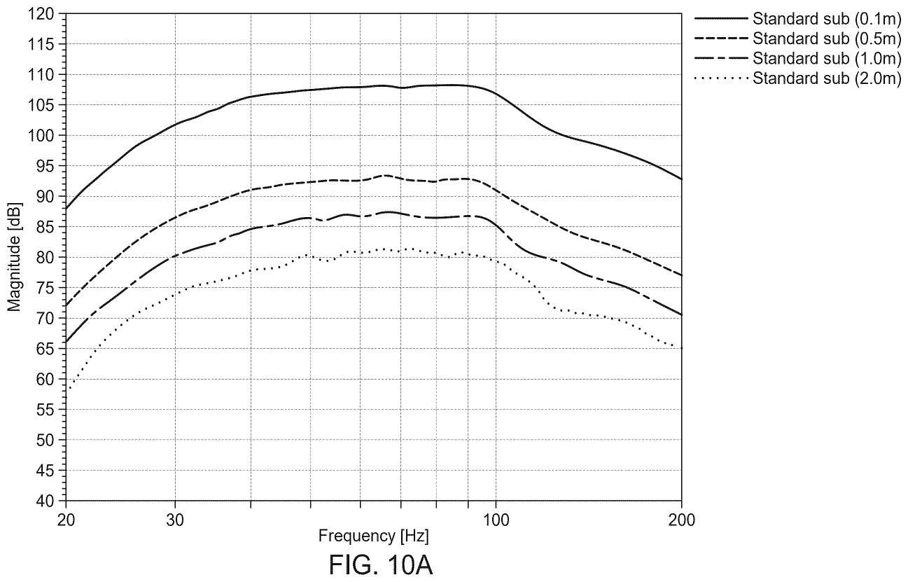

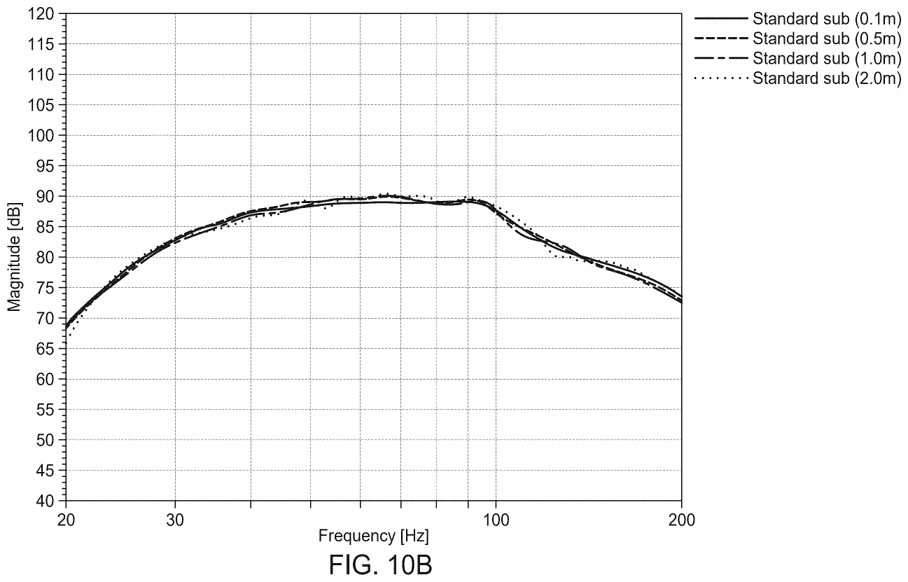

FIG. 10A illustrates the correlation between the operating frequency and the magnitude of sound pressure level produced by a conventional sealed speaker assembly 100 measured at various distances from the conventional sealed speaker assembly 100 within a qualified anechoic chamber. An anechoic chamber is a room designed to minimize reflected sound waves and to prevent audible sound related energy from entering into the room from external surroundings. A qualified anechoic chamber has been tested to ensure it can support free field conditions to create an environment where sound waves can propagate without interference from reflecting surfaces, boundaries, or obstacles. FIG. 10B normalizes the data shown in FIG. 10A to emphasize the difference in correlations of the measurements at various distances. As can be seen from FIG. 10B, the changes in sound pressure level as frequency increases remains substantially consistent regardless of the distance of the listener from the conventional sealed speaker assembly 100.

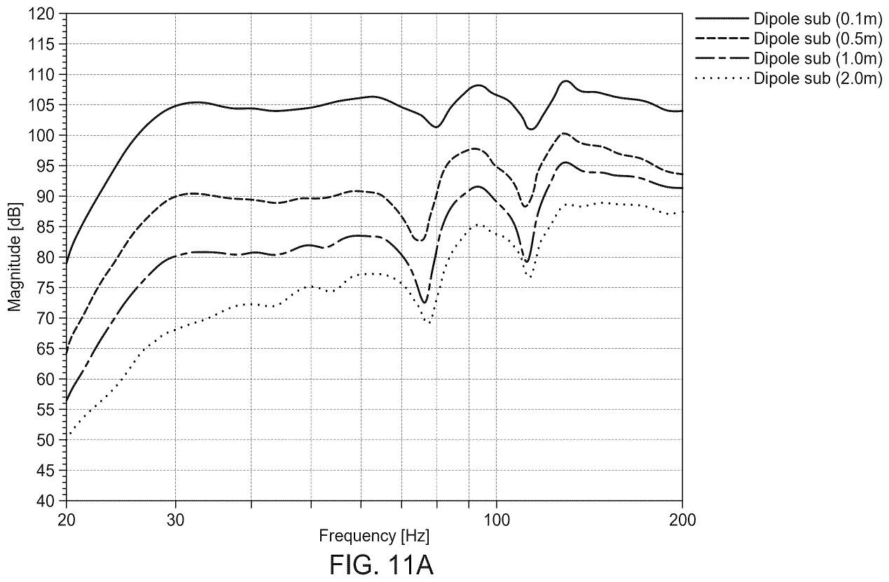

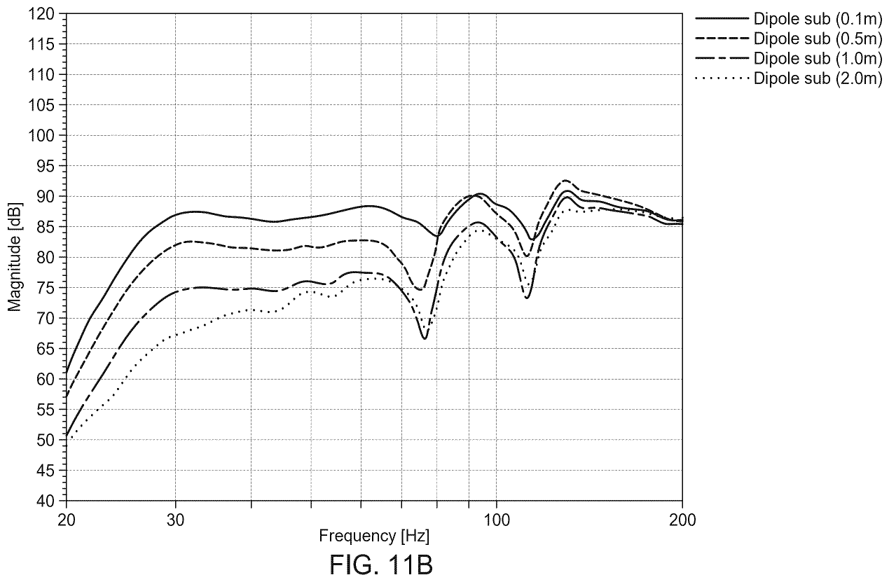

FIG. 11A illustrates the correlation between the operating frequency and the magnitude of sound pressure level produced by a dipole speaker assembly 200 measured at various distances from the dipole speaker assembly 200 within a qualified anechoic chamber. FIG. 11B normalizes the data shown in FIG. 11A to emphasize the difference in correlations of the measurements at various distances. As can be seen from FIG. 11B, the changes in sound pressure level as frequency increases are not substantially consistent regardless of the distance of the listener from the dipole speaker assembly 200. As the frequency increases, the changes in sound pressure level become somewhat more consistent. However, there is much more variation as can be seen when comparing the normalized data of FIG. 11B to the normalized data of the conventional sealed speaker assembly 100 displayed in FIG. 10B.

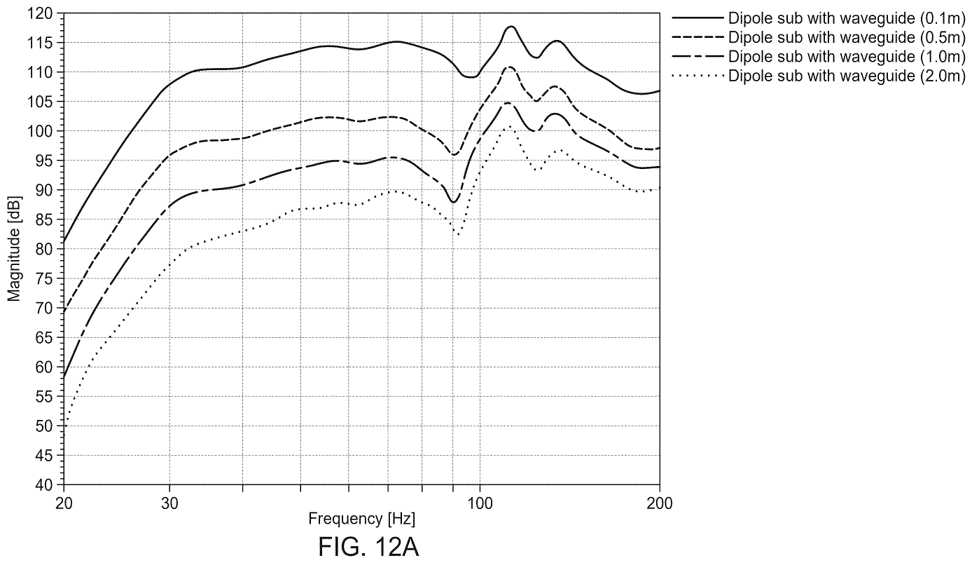

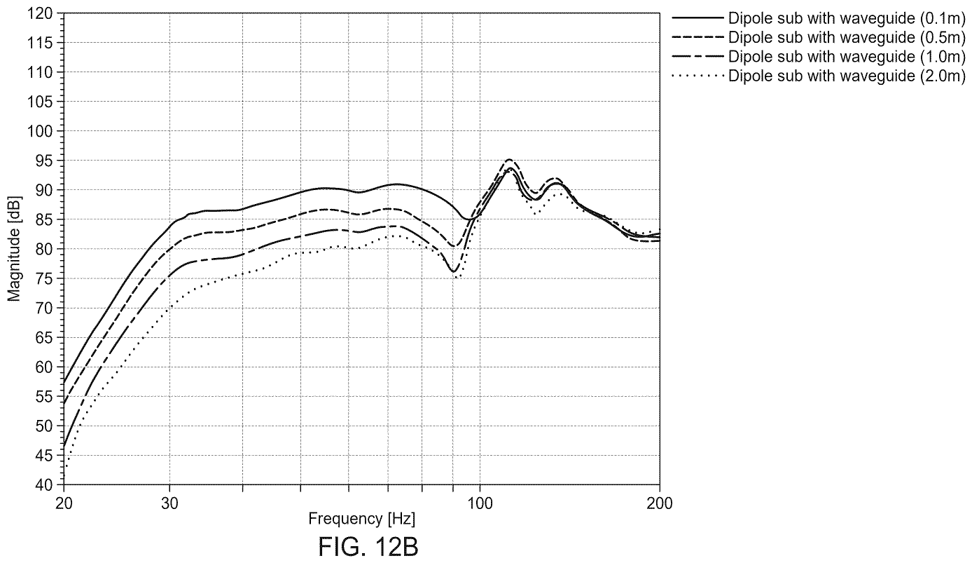

FIG. 12A illustrates the correlation between the operating frequency and the magnitude of sound pressure level produced by a dipole speaker assembly 200 including an angled top port 705 measured at various distances from the dipole speaker assembly 200 within a qualified anechoic chamber. FIG. 12B normalizes the data shown in FIG. 12A to emphasize the difference in correlations of the measurements at various distances. As can be seen from FIG. 12B, the changes in sound pressure level as frequency increases are not substantially consistent regardless of the distance of the listener from dipole speaker assembly 200 including an angled top port 705. The dipole speaker assembly 200 with an angled top port 705 follows a similar trend as the dipole speaker assembly 200 without an angled top port 705 in that as the frequency increases, the changes in sound pressure level become somewhat more consistent. However, one skilled in the art will note that there is less variation in the embodiment that includes the angled top port 705 than without the angled top port 705.

As compared to FIGS. 11A, 11B, 12A, and 12B, FIGS. 10A and 10B illustrate a more uniform sound pressure level pattern throughout a qualified anechoic chamber including a conventional sealed speaker assembly. FIGS. 11A, 11B, 12A, and 12B illustrate the non-uniformity of sound pressure level throughout a qualified anechoic chamber including a dipole speaker assembly 200.

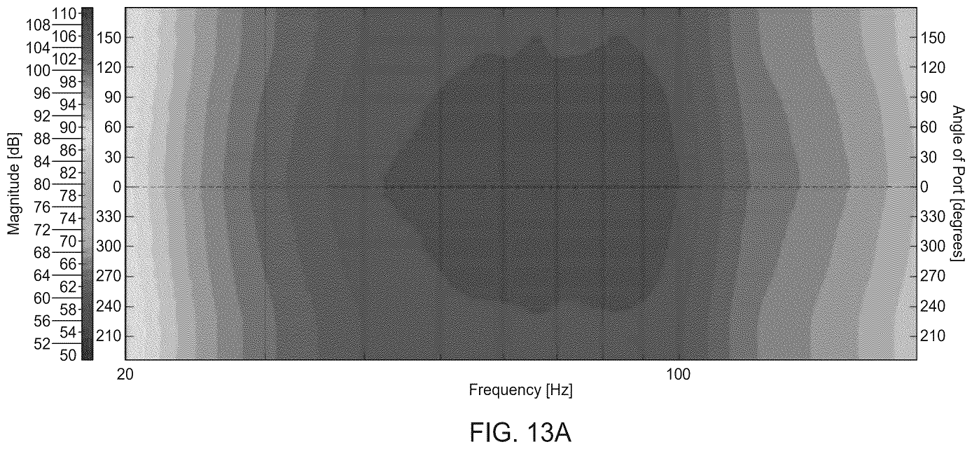

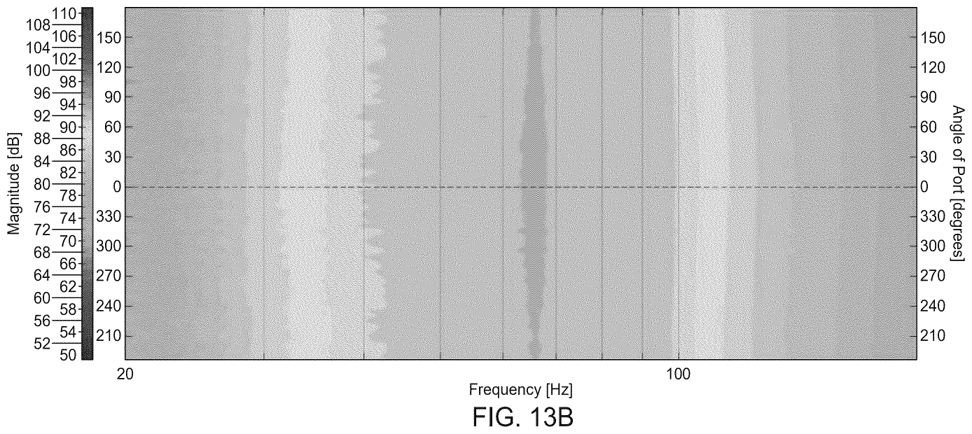

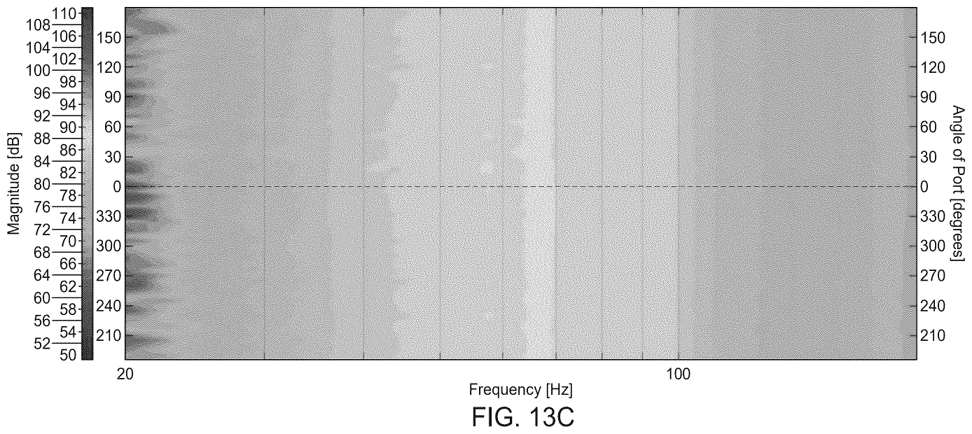

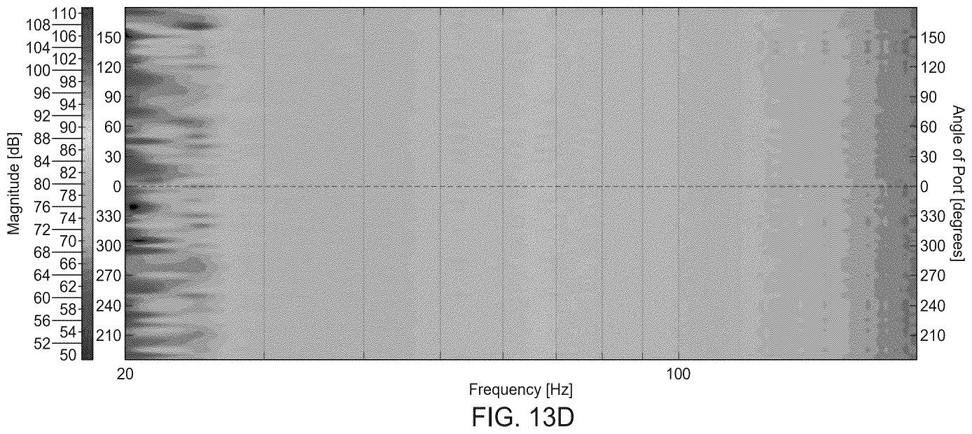

FIGS. 13A-13D illustrate measured sound pressure level maps of a conventional sealed speaker assembly operating at various frequencies. Further, the measurements of FIGS. 13A-13D illustrate the sound pressure level at all positions in a circle around a first end of the conventional sealed speaker assembly. Each Figure illustrates measurements taken at a different radius from the conventional sealed speaker assembly.

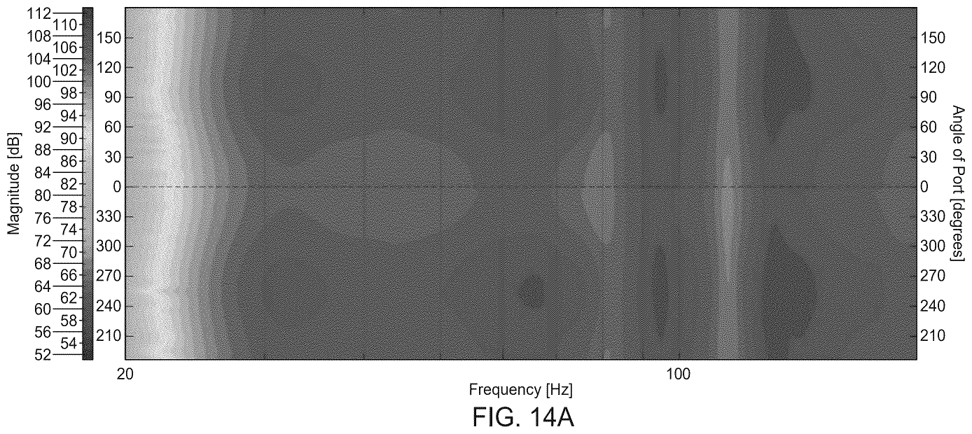

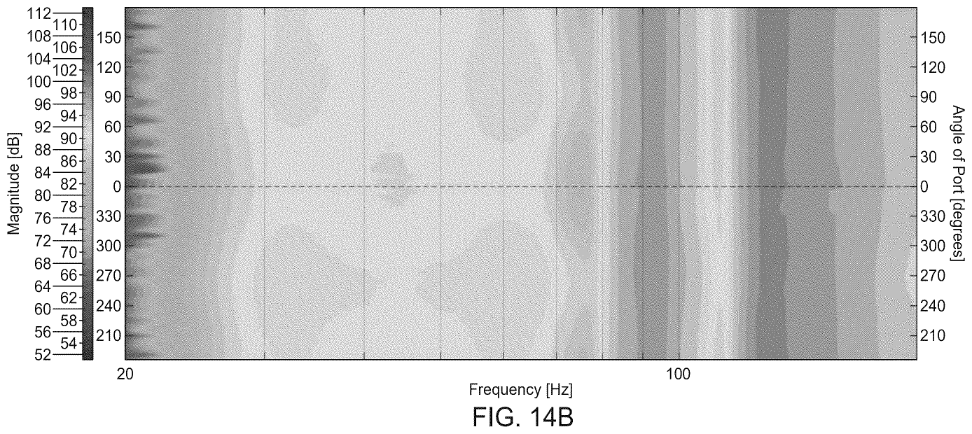

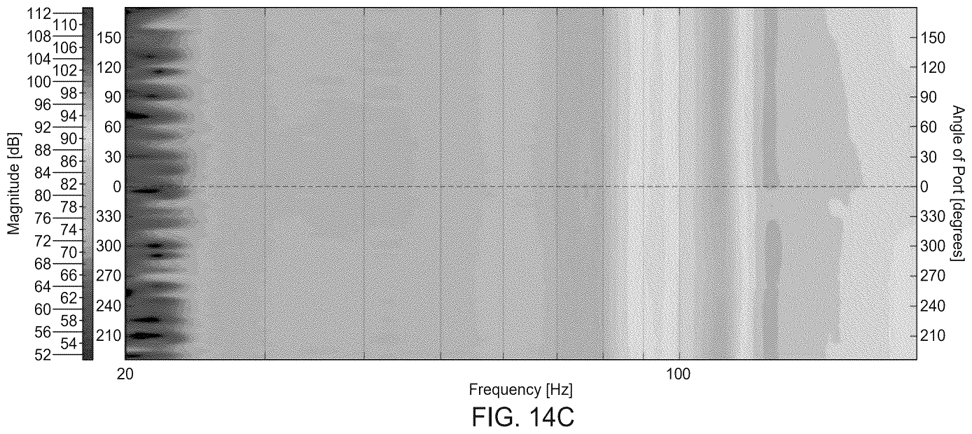

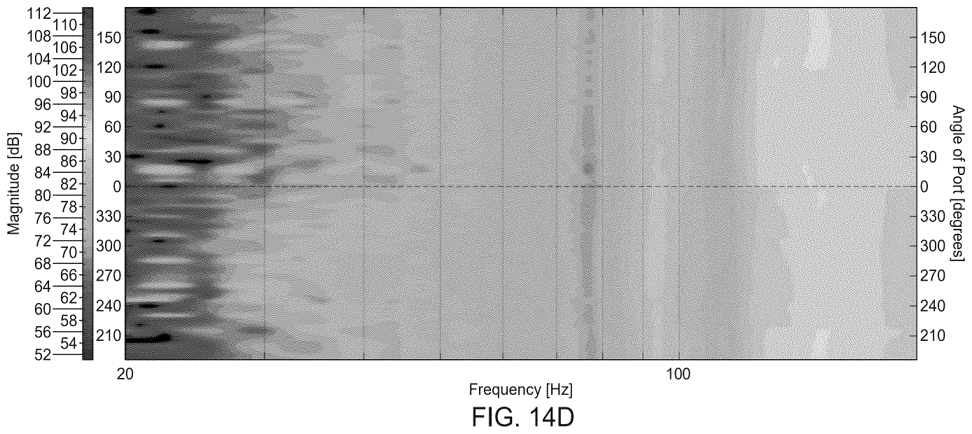

FIGS. 14A-14D illustrate similar sound pressure level maps of a dipole speaker assembly 200.

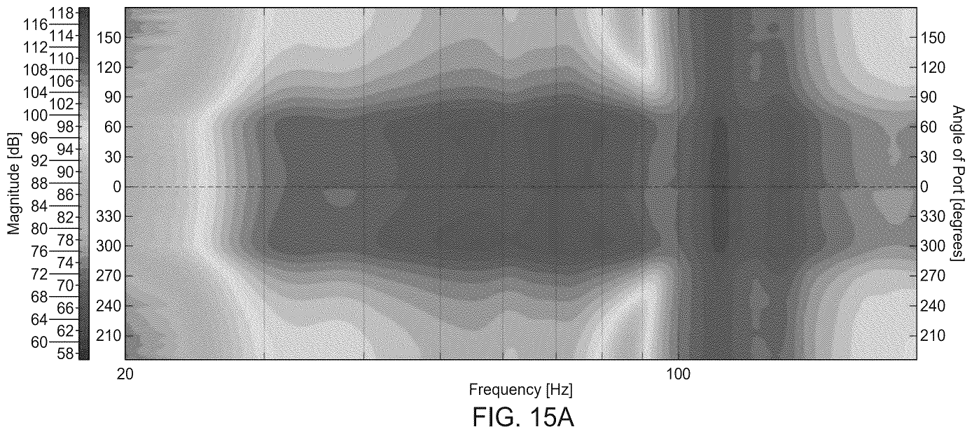

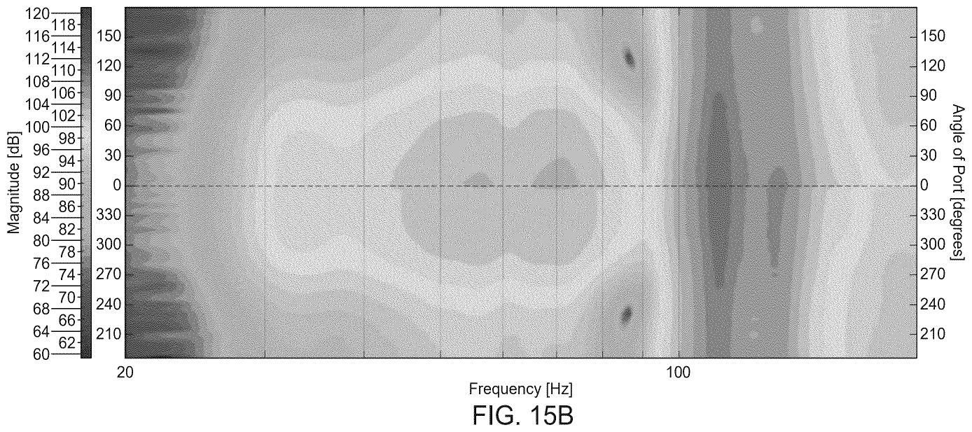

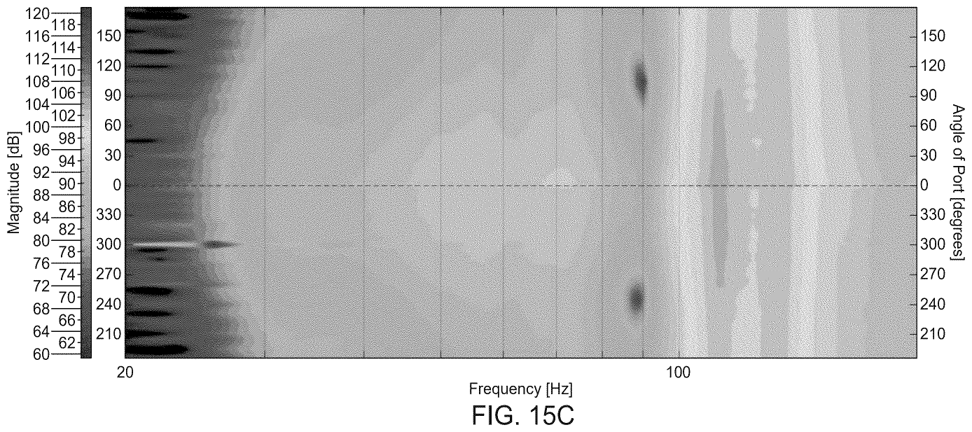

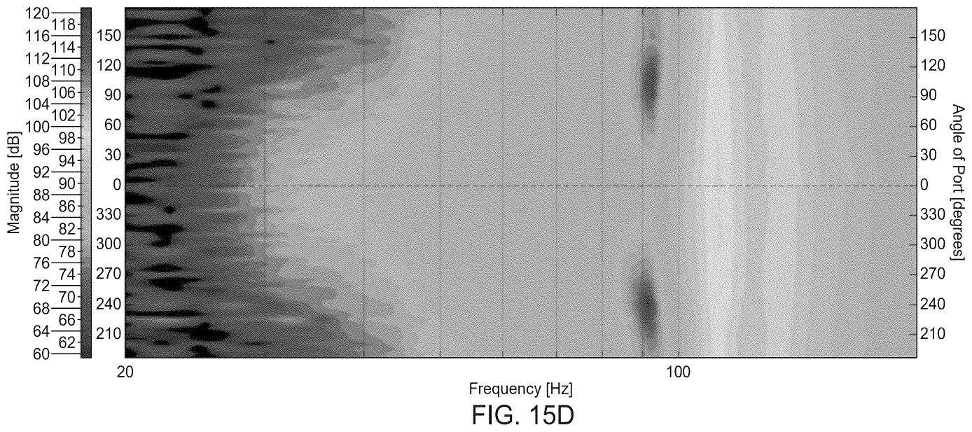

FIGS. 15A-15D illustrate sound pressure level maps of a dipole speaker assembly 200 including an angled top port 705.

FIGS. 14A-14D and FIGS. 15A-15D illustrate a more rapid decline in sound pressure level than FIGS. 13A-13D, specifically within the lower frequency ranges, such as between 20 Hz to 40 Hz.

The preceding discussion is directed to various embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

Any one or more components of the various embodiments disclosed herein may be integrally formed together, directly coupled together, and/or indirectly coupled together and are not limited to the specific arrangement of components illustrated in FIGS. 1A-18. Any one or more of the components, embodiments, or steps of the embodiments disclosed herein may be combined in whole or part with any other components, embodiments, or steps of the embodiments disclosed herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits, and ranges appear in one or more claims below.

In the preceding discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections.

Certain embodiments and features have been described using the term “about,” “generally,” “substantially,” and/or “generally.” When any of these terms are used in conjunction with a numerical value, it should be construed as indicating any numerical value within 10% of the stated numerical value.

While the foregoing is directed to embodiments of the present disclosure, other and further embodiments of the disclosure may be devised without departing from the basic scope thereof, and the scope thereof is determined by the claims that follow.

What is claimed is:

1. A speaker assembly, comprising:
a waveguide comprising:
a first sound opening positioned at a first end of the waveguide;
a second sound opening positioned at a second end of the waveguide; and
an internal region that extends between the first sound opening and the second sound opening;
a driver coupled to the waveguide, wherein the driver comprises a diaphragm that separates a first portion of the internal region disposed on a first side of the driver from a second portion of the internal region disposed on a second side of the driver; and
a supporting structure comprising a supporting element that is configured to support a portion of a user, wherein the waveguide is coupled to the supporting structure through a coupling.

2. The speaker assembly of claim 1, wherein the supporting structure is configured to cause a position of a head of the user to be at or within one meter from the first sound opening when the user is positioned on the supporting element.

3. The speaker assembly of claim 2, wherein the first sound opening faces the position of the user's head.

4. The speaker assembly of claim 1, wherein the supporting structure comprises a seat and a back support, wherein the coupling is coupled to at least one of the seat and the back support.

5. The speaker assembly of claim 1, wherein the coupling comprises a metal or a plastic.

6. The speaker assembly of claim 1, wherein the coupling is configured to transmit at least 60% of a magnitude of vibrations generated by the driver.

7. The speaker assembly of claim 1, further comprising an actuating mechanism configured to adjust a rigidity of the coupling, wherein adjusting the rigidity of the coupling alters a magnitude of vibrations transmitted from the waveguide to the supporting element.

8. The speaker assembly of claim 1, wherein the coupling is positioned proximate to the driver and the second sound opening.

9. The speaker assembly of claim 1, wherein a length of the first portion of the internal region is at least 0.4 meters long.

10. The speaker assembly of claim 1, wherein
the driver is configured to deliver sound waves at frequencies less than a first frequency that has a first wavelength,
the waveguide comprises a length that extends between the first sound opening and the second sound opening, and
the length is at least greater than a quarter (¼) of the first wavelength.

11. The speaker assembly of claim 1, wherein the driver is configured to deliver sound waves at frequencies less than about 200 hertz (Hz).

12. The speaker assembly of claim 1, wherein the driver is configured to deliver sound waves only at frequencies between about 20 Hz and about 100 Hz.

13. The speaker assembly of claim 1, wherein the driver is configured to deliver sound waves at frequencies no greater than about 200 hertz (Hz).

14. The speaker assembly of claim 1, wherein the first sound opening comprises a non-circular shaped opening.

15. The speaker assembly of claim 1, wherein the first sound opening comprises at least two sound openings.

16. The speaker assembly of claim 15, wherein a sum of the cross-sectional areas of the at least two openings is at least 80% of the area of the driver.

17. A speaker assembly, comprising:
a waveguide comprising:
a first sound opening positioned at a first end of the waveguide;
a second sound opening positioned at a second end of the waveguide; and
an internal region that extends between the first sound opening and the second sound opening;
a driver coupled to the waveguide, wherein the driver comprises a diaphragm that separates a first portion of the internal region disposed on a first side of the driver from a second portion of the internal region disposed on a second side of the driver; and
a supporting structure comprising a supporting element that is configured to support a portion of a user, wherein the waveguide is coupled to the supporting structure through a coupling,
wherein a cross-sectional area at any point along a length of the first portion of the internal region that extends from the first side of the driver to the first sound opening is at least 80% of the area of the driver.

18. The speaker assembly of claim 17, wherein the driver is configured to deliver sound waves at frequencies no greater than about 200 hertz (Hz).

19. The speaker assembly of claim 17, wherein the supporting structure comprises a seat and a back support, wherein the coupling is coupled to one of the seat or the back support.

20. The speaker assembly of claim 19, wherein the supporting structure further comprises a tunable layer disposed below the seat, wherein the tunable layer is configured to alter a transmission of vibrations between the waveguide and the supporting element.

21. The speaker assembly of claim 20, wherein
the driver is configured to deliver sound waves at frequencies no greater than about 200 hertz (Hz), and
the tunable layer comprises a resonant frequency within 2% of a frequency within the sound waves delivered by the driver.

22. A method of generating an audible sound, comprising:
generating haptic vibrations from a speaker assembly at frequencies less than Hz, wherein the speaker assembly comprises:
a waveguide comprising:
a first sound opening positioned at a first end of the waveguide; and
a second sound opening positioned at a second end of the waveguide; and
a driver coupled to the waveguide, wherein the driver comprises
a diaphragm that separates an internal region of the waveguide disposed on a first side of the driver from a second side of the driver, and wherein
the frequencies of the generated haptic vibrations comprise at least a first frequency, and
a length of the internal region, which extends between the first side of the driver and the first opening, is at least a quarter wavelength of the first frequency.

23. The method of claim 22, further comprising a supporting structure comprising a supporting element that is configured to support a portion of a user, wherein the waveguide is coupled to the supporting structure through a coupling.

24. The method of claim 23, wherein the supporting structure comprises a seat and a back support.

25. The method of claim 24, wherein the supporting structure comprises a tunable layer positioned below the seat, and wherein the tunable layer transmits the haptic vibrations to the supporting structure.
